(19) United States
(12) Patent Application Publication
(10) Pub. No.: US 2025/0317941 A1
(43) Pub. Date: Oct. 9, 2025

(54) JOINT ACTIVATION AND/OR DEACTIVATION DOWNLINK CONTROL INFORMATION ASSOCIATED WITH MULTIPLE SEMI-PERSISTENT COMMUNICATION CONFIGURATIONS

(71) Applicant: QUALCOMM INCORPORATED, San Diego, CA (US)

(72) Inventors: Fang YUAN, Beijing (CN); Iyab Issam SAKHNINI, San Diego, CA (US); Tao LUO, San Diego, CA (US)

(21) Appl. No.: 18/864,718

(22) PCT Filed: Jul. 29, 2022
(86) PCT No.: PCT/CN2022/109010

§ 371 Date: Nov. 11, 2024

(51) Int. Cl. H04W 72/232; H04L 1/1812

(52) U.S. Cl. CPC H04W 72/232; H04L 1/1812

(57) ABSTRACT

Various aspects of the present disclosure generally relate to wireless communication. In some aspects, a network node may receive configuration information indicative of a plurality of semi-persistent communication configurations, wherein each semi-persistent communication configuration corresponds to a respective configuration index of a plurality of configuration indexes. The network node may receive a downlink control information (DCI) transmission comprising a joint activation or deactivation indication indicative of an activation or a deactivation of a set of semi-persistent communication configurations of the plurality of semi-persistent communication configurations, the set of semi-persistent communication configurations comprising one or more semi-persistent communication configurations. The network node may communicate based on the set of semi-persistent communication configurations. Numerous other aspects are described.

### INTRODUCTION

Aspects of the present disclosure generally relate to wireless communication and to techniques and apparatuses for semi-persistent communications.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a network node for wireless communication. The network node may include a memory and one or more processors coupled to the memory. The one or more processors may be configured to receive configuration information indicative of a plurality of semi-persistent communication configurations, wherein each semi-persistent communication configuration corresponds to a respective configuration index of a plurality of configuration indexes. The one or more processors may be configured to receive a downlink control information (DCI) transmission comprising a joint activation indication indicative of an activation of a set of semi-persistent communication configurations of the plurality of semi-persistent communication configurations, the set of semi-persistent communication configurations comprising one or more semi-persistent communication configurations. The one or more processors may be configured to communicate based on the set of semi-persistent communication configurations.

Some aspects described herein relate to a network node for wireless communication. The network node may include a memory and one or more processors coupled to the memory. The one or more processors may be configured to transmit, configuration information indicative of a plurality of semi-persistent communication configurations, wherein each semi-persistent communication configuration corresponds to a respective configuration index of a plurality of configuration indexes. The one or more processors may be configured to transmit a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The one or more processors may be configured to communicate based on the set of semi-persistent communication configurations.

Some aspects described herein relate to a network node for wireless communication. The network node may include a memory and one or more processors coupled to the memory. The one or more processors may be configured to receive configuration information indicative of a plurality of semi-persistent communication configurations, wherein each semi-persistent communication configuration corresponds to a respective configuration index of a plurality of configuration indexes. The one or more processors may be configured to receive a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Some aspects described herein relate to a network node for wireless communication. The network node may include a memory and one or more processors coupled to the memory. The one or more processors may be configured to transmit configuration information indicative of a plurality of semi-persistent communication configurations, wherein each semi-persistent communication configuration corresponds to a respective configuration index of a plurality of configuration indexes. The one or more processors may be configured to transmit a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Some aspects described herein relate to a method of wireless communication performed by a network node. The method may include receiving configuration information indicative of a plurality of semi-persistent communication configurations, wherein each semi-persistent communication configuration corresponds to a respective configuration index of a plurality of configuration indexes. The method may include receiving a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The method may include communicating based on the set of semi-persistent communication configurations.

Some aspects described herein relate to a method of wireless communication performed by a network node. The method may include transmitting, configuration information indicative of a plurality of semi-persistent communication configurations, wherein each semi-persistent communication configuration corresponds to a respective configuration index of a plurality of configuration indexes. The method may include transmitting a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The method may include communicating based on the set of semi-persistent communication configurations.

Some aspects described herein relate to a method of wireless communication performed by a network node. The method may include receiving configuration information indicative of a plurality of semi-persistent communication configurations, wherein each semi-persistent communication configuration corresponds to a respective configuration index of a plurality of configuration indexes. The method may include receiving a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Some aspects described herein relate to a method of wireless communication performed by a network node. The method may include transmitting configuration information indicative of a plurality of semi-persistent communication configurations, wherein each semi-persistent communication configuration corresponds to a respective configuration index of a plurality of configuration indexes. The method may include transmitting a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Some aspects described herein relate to a non-transitory computer-readable medium that stores a set of instructions for wireless communication by a network node. The set of instructions, when executed by one or more processors of the network node, may cause the network node to receive configuration information indicative of a plurality of semi-persistent communication configurations, wherein each semi-persistent communication configuration corresponds to a respective configuration index of a plurality of configuration indexes. The set of instructions, when executed by one or more processors of the network node, may cause the network node to receive a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The set of instructions, when executed by one or more processors of the network node, may cause the network node to communicate based on the set of semi-persistent communication configurations.

Some aspects described herein relate to a non-transitory computer-readable medium that stores a set of instructions for wireless communication by a network node. The set of instructions, when executed by one or more processors of the network node, may cause the network node to transmit, configuration information indicative of a plurality of semi-persistent communication configurations, wherein each semi-persistent communication configuration corresponds to a respective configuration index of a plurality of configuration indexes. The set of instructions, when executed by one or more processors of the network node, may cause the network node to transmit a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The set of instructions, when executed by one or more processors of the network node, may cause the network node to communicate based on the set of semi-persistent communication configurations.

Some aspects described herein relate to a non-transitory computer-readable medium that stores a set of instructions for wireless communication by a network node. The set of instructions, when executed by one or more processors of the network node, may cause the network node to receive configuration information indicative of a plurality of semi-persistent communication configurations, wherein each semi-persistent communication configuration corresponds to a respective configuration index of a plurality of configuration indexes. The set of instructions, when executed by one or more processors of the network node, may cause the network node to receive a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Some aspects described herein relate to a non-transitory computer-readable medium that stores a set of instructions for wireless communication by a network node. The set of instructions, when executed by one or more processors of the network node, may cause the network node to transmit configuration information indicative of a plurality of semi-persistent communication configurations, wherein each semi-persistent communication configuration corresponds to a respective configuration index of a plurality of configuration indexes. The set of instructions, when executed by one or more processors of the network node, may cause the network node to transmit a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Some aspects described herein relate to an apparatus for wireless communication. The apparatus may include means for receiving configuration information indicative of a plurality of semi-persistent communication configurations, wherein each semi-persistent communication configuration corresponds to a respective configuration index of a plurality of configuration indexes. The apparatus may include means for receiving a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The apparatus may include means for communicating based on the set of semi-persistent communication configurations.

Some aspects described herein relate to an apparatus for wireless communication. The apparatus may include means for transmitting, configuration information indicative of a plurality of semi-persistent communication configurations, wherein each semi-persistent communication configuration corresponds to a respective configuration index of a plurality of configuration indexes. The apparatus may include means for transmitting a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The apparatus may include means for communicating based on the set of semi-persistent communication configurations.

Some aspects described herein relate to an apparatus for wireless communication. The apparatus may include means for receiving configuration information indicative of a plurality of semi-persistent communication configurations, wherein each semi-persistent communication configuration corresponds to a respective configuration index of a plurality of configuration indexes. The apparatus may include means for receiving a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Some aspects described herein relate to an apparatus for wireless communication. The apparatus may include means for transmitting configuration information indicative of a plurality of semi-persistent communication configurations, wherein each semi-persistent communication configuration corresponds to a respective configuration index of a plurality of configuration indexes. The apparatus may include means for transmitting a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram of example components of an apparatus, in accordance with the present disclosure.

FIG. 3 is a diagram illustrating an example of a wireless network, in accordance with the present disclosure.

FIG. 4 is a diagram illustrating an environment including a network node in wireless communication with a network node (e.g., via a network such as the network depicted in FIG. 1 and/or the wireless network depicted in FIG. 3), in accordance with the present disclosure.

FIG. 5 is a diagram illustrating an example disaggregated base station architecture, in accordance with the present disclosure.

FIG. 6A is a diagram illustrating an example associated with joint activation and/or deactivation DCI associated with multiple semi-persistent communication configurations, in accordance with the present disclosure.

FIG. 6B is a diagram illustrating an example of joint activation DCI associated with multiple semi-persistent communication configurations, in accordance with the present disclosure.

FIG. 6C is a diagram illustrating an example of joint activation DCI associated with multiple semi-persistent communication configurations, in accordance with the present disclosure.

FIG. 6D is a diagram illustrating an example of joint deactivation DCI associated with multiple semi-persistent communication configurations, in accordance with the present disclosure.

FIG. 6E is a diagram illustrating an example of joint deactivation DCI associated with multiple semi-persistent communication configurations, in accordance with the present disclosure.

FIG. 7 is a diagram illustrating an example associated with joint activation DCI associated with multiple semi-persistent communication configurations, in accordance with the present disclosure.

FIG. 8 is a diagram illustrating an example associated with joint deactivation DCI associated with multiple semi-persistent communication configurations, in accordance with the present disclosure.

FIG. 9 is a diagram illustrating an example process performed, for example, by a network node, in accordance with the present disclosure.

FIG. 10 is a diagram illustrating an example process performed, for example, by a network node, in accordance with the present disclosure.

FIG. 11 is a diagram illustrating an example process performed, for example, by a network node, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

### DETAILED DESCRIPTION

A first network node (e.g., a user equipment (UE) and/or an extended reality (XR) device) may communicate with a second network node (e.g., a base station, relay device, and/or a UE) via a multi-channel communication such as a single-downlink control information (DCI) multiple physical downlink shared channel (PDSCH) communication or a single-DCI multiple physical uplink shared channel (PUSCH) communication. A multi-channel communication is a communication in which data is transmitted or received via more than one data channel. In some cases, the data transmitted or received via one channel of the multi-channel communication may be at least partially the same as the data transmitted or received via another channel of the multi-channel communication. In some cases, the data transmitted or received via one channel of the multi-channel communication may be different than the data transmitted or received via another channel of the multi-channel communication. Multi-channel communications are particularly beneficial for semi-persistent communications (e.g., semi-persistent scheduling (SPS) and/or configured grant (CG) communications), since a multi-channel communication is associated with lower control overhead than a communication in which DCI needs to be provided for each separate PUSCH or PDSCH of the communication, and uplink semi-persistent transmissions may reduce latency relative to transmitting a separate scheduling request for each PUSCH.

Semi-persistent communication configurations are configurations associated with semi-persistent communications. Semi-persistent communications are communications that are configured such that more than one configured communication can occur without requiring activation and/or dynamic scheduling of each communication. For example, in semi-persistent communications, two or more semi-persistent communication occasions may be configured so that, once the semi-persistent communication configuration is activated, a communication may occur during each of the two or more semi-persistent communications. In some aspects, semi-persistent communication configurations may include SPS configurations and configured grant (CG) configurations.

One example of a periodic communication is an XR communication. “XR” is a term referring to real-and-virtual combined environments and human-machine interactions generated by computer technology and wearables. For example, an XR environment may be used to implement a metaverse scene or network. Non-exhaustive examples of XR include augmented reality, mixed reality, and virtual reality. XR may involve some amount of network communication. An XR communication is a transmission or series of transmissions (e.g., a traffic flow) associated with an XR application, such as a traffic flow carrying XR data. The XR application may be implemented on a network node such as an XR device and/or a UE, among other examples. An XR device may include, for example, an XR headset, a laptop, a personal computer, a gaming console, and/or a UE, among other examples. In some implementations, some amount of processing may be performed at a server, such as to generate a scene (e.g., frame) which is communicated to the XR device via a traffic burst. A traffic burst may include one or more packets and may be associated with a scene (e.g., frame) of an XR application. For example, a traffic burst may carry the data associated with the scene (e.g., frame). As another example, a network node may access data stored remotely for use in an XR environment. In some cases, an XR communication may be associated with multiple traffic flows, such as a video traffic flow, an audio traffic flow, and a haptic traffic flow.

While multi-channel communications may facilitate XR communications, challenges may arise due to the configuration of multi-channel communications. For example, the forms of multi-channel communication described above (and in more detail below) typically have a static configuration across all of the data channels of the multi-channel communication, meaning that at least some communication parameters are the same for each data channel of the multi-channel communication (e.g., at least some parameters of a first data channel of the multi-channel communication are also parameters of a second data channel of the multi-channel communication and of each other data channel of the multi-channel communication). However, some periodic communications, such as XR communications, may be inherently variable. For example, XR communications may be associated with variability in the number of packets per traffic burst and in the size of each packet. As another example, in some cases, a periodicity of XR communications (which may be based at least in part on a framerate of an XR application) may not match a configurable set of periodicities of a multi-channel communication. As yet another example, the arrival times of XR traffic may vary due to jitter (where jitter is a variation or uncertainty in the arrival time of a communication, such as an expected or observed deviation of an actual arrival time of a packet relative to a scheduled arrival time of the packet). As still another example, multiple traffic flows of XR communications may have variable parameters and characteristics, such as different data rates, different latency or reliability requirements, different packet sizes, and so on. If a multi-channel communication has a static configuration across each data channel of the multi-channel communication, then the variability of periodic communications (such as XR communications) may lead to underutilization of the multi-channel communication's data channels, delay in traffic arrival, and/or dropped traffic. Reducing the impact of these conditions may positively impact user experience, improve throughput, and expand the usability of XR applications. Semi-persistent communication configurations such as SPS and/or CG can be used to improve XR network performance. However, in some cases, SPS and/or CG activation can only be performed separately. In some cases, multiple SPS configurations and/or CG configurations may be activated and/or deactivated jointly (e.g., simultaneously), but using only single PDSCH/PUSCH DCI.

Some techniques described herein provide for joint activation and/or deactivation of multiple semi-persistent communication configurations using multi-shared channel DCI. In some aspects, for example, a single activation DCI transmission may be used to jointly activate multiple semi-persistent communication configurations. Each semi-persistent communication configuration may correspond to a different respective configuration index. For example, a first semi-persistent communication configuration may correspond to a first PUSCH index and a second semi-persistent communication configuration may correspond to a second PUSCH index. In some aspects, the multiple semi-persistent communication configurations may be radio resource control (RRC) configured and associated with a hybrid automatic repeat request (HARQ) identifier (ID) in the DCI. The HARQ ID may be used to indicate an activation or a deactivation of a set of semi-persistent communication configurations. In some aspects, the set of semi-persistent communication configurations may correspond to a set of uplink communications or a set of downlink communications. A set of semi-persistent communication configurations includes one or more semi-persistent communication configurations.

In this way, some aspects described herein may facilitate joint activation and/or release of multiple semi-persistent communication configurations using a multi-shared channel DCI transmission, thereby reducing control signal overhead associated with the activations and/or deactivations while achieving the resource allocation efficiencies provided by using multiple semi-persistent communication configurations. As a result, some aspects may facilitate XR-specific power savings and resource allocation, which may decrease jitter and/or latency, while increasing reliability. For example, because the multi-shared channel DCI transmission described herein may activate or deactivate multiple semi-persistent communication configurations associated with multiple data channels, the receiving UE may decode only one DCI transmission instead of two or more DCI transmissions, thereby requiring fewer processing resources to receive activations and deactivations, thereby reducing power consumption. Additionally, decoding only one DCI transmission instead of multiple DCI transmissions may free up time and/or frequency resources that may be used for XR data and may facilitate a reduction in time delays in receiving XR data. In some aspects, a first network node may be provided with a semi-persistent communication configuration activation state set (e.g., a configured grant activation state list and/or an SPS activation state list), which may be reused for indication of the activation and/or deactivation of the multiple semi-persistent communication configurations. In this way, further decreases in control signal overhead may be achieved in accordance with some aspects described herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

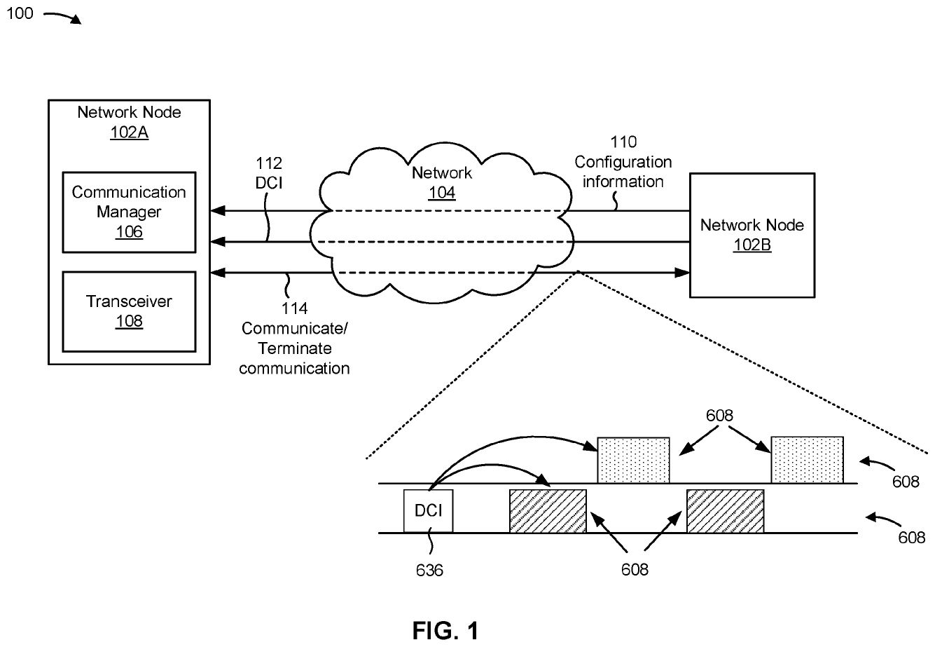

FIG. 1 is a diagram illustrating an example environment 100 in which apparatuses and/or methods described herein may be implemented, in accordance with the present disclosure. As shown in FIG. 1, the environment 100 may include a network node 102A and a network node 102B that may communicate with one another via a network 104. The network nodes 102A and 102B may be dispersed throughout the network 104, and each network node 102A and 102B may be stationary and/or mobile. The network 104 may include wired communication connections, wireless communication connections, or a combination of wired and wireless communication connections.

The network 104 may include, for example, a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

In general, any number of networks 104 may be deployed in a given geographic area. Each network 104 may support a particular radio access technology (RAT) and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, Open-RAT, New Radio (NR) or 5G RAT networks may be deployed.

In some aspects, the environment 100 may include one or more non-terrestrial network (NTN) deployments in which a non-terrestrial wireless communication device may include a non-terrestrial network node (e.g., the network node 102A and 102B). The non-terrestrial network node may include a network node such as, for example, a UE (which may be referred to herein, interchangeably, as a “non-terrestrial UE”), a base station (referred to herein, interchangeably, as a “non-terrestrial BS” and “non-terrestrial base station”), and/or a relay station (referred to herein, interchangeably, as a “non-terrestrial relay station”), among other examples. As used herein, “NTN” may refer to a network for which access is facilitated by a non-terrestrial network node such as a non-terrestrial UE, a non-terrestrial base station, and/or a non-terrestrial relay station, among other examples.

One or more of the network nodes 102A and 102B may be, include, or be included in, any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. Satellites may communicate directly and/or indirectly with other entities in the environment using satellite communication. The other entities may include UEs (e.g., terrestrial UEs and/or non-terrestrial UEs), other satellites in the one or more NTN deployments, other types of base stations (e.g., stationary and/or ground-based BSs), relay stations, and/or one or more components and/or devices included in a core network, among other examples.

As described herein, a network node (which may alternatively be referred to as a node, a network entity, or a wireless node) may be, be similar to, include, or be included in (e.g., be a component of) a base station (e.g., any base station described herein, including a disaggregated base station), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), an XR device, and/or another processing entity configured to perform any of the techniques described herein. For example, a network node may be a UE. As another example, a network node may be a base station or other network entity.

The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. As an example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples.

Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

As shown, the network node 102A may include a communication manager 106 and a transceiver 108. The communication manager 106 may be configured to perform one or more communication tasks as described herein. In some aspects, the communication manager 106 may direct the transceiver 108 to perform one or more communication tasks as described herein. Although depicted, for clarity of description, with reference only to the network node 102A, the network node 102B also may include a communication manager and a transceiver.

In some aspects, as shown by reference number 110, the network node 102B may transmit, and the network node 102A, via the communication manager 106 and/or the transceiver 108, may receive configuration information. The configuration information may be indicative of a plurality of semi-persistent communication configurations, and each semi-persistent communication configuration may correspond to a respective configuration index of a plurality of configuration indexes. As shown by reference number 112, the network node 102B may transmit, and the network node 102A, via the communication manager 106 and/or the transceiver 108, may receive a DCI transmission. The DCI transmission may include a joint activation or deactivation indication indicative of an activation of a set of semi-persistent communication configurations of the plurality of semi-persistent communication configurations. The set of semi-persistent communication configurations may include one or more semi-persistent communication configurations. As shown by reference number 114, the network node 102A and the network node 102B may communicate (or terminate communication in the case of the DCI transmission including a deactivation indication) based on the set of semi-persistent communication configurations. Additionally, or alternatively, the communication manager 106 and/or the transceiver 108 may perform one or more other operations described herein.

The number and arrangement of entities shown in FIG. 1 are provided as one or more examples. In practice, there may be additional network nodes and/or networks, fewer network nodes and/or networks, different network nodes and/or networks, or differently arranged network nodes and/or networks than those shown in FIG. 1. Furthermore, the network node 102A and 102B may be implemented using a single apparatus or multiple apparatuses.

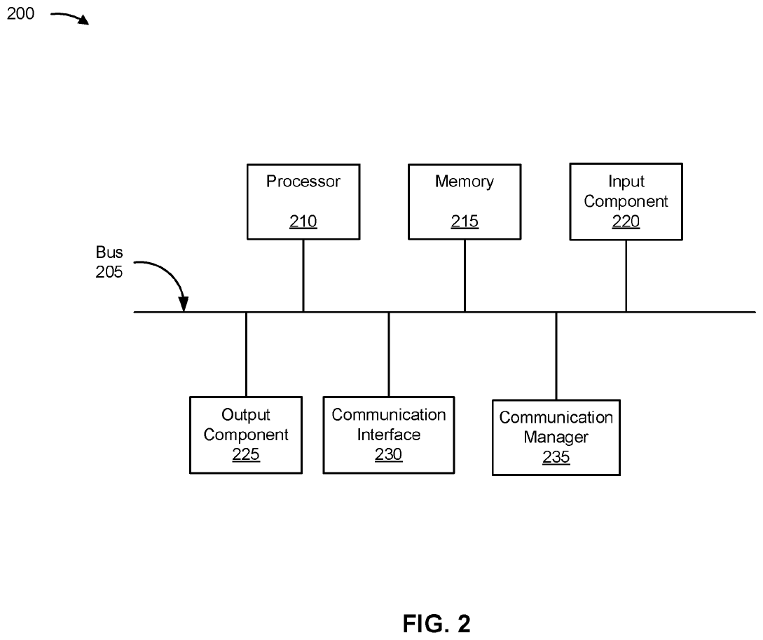

FIG. 2 is a diagram of example components of an apparatus 200, in accordance with the present disclosure. The apparatus 200 may correspond to any one or more of the network nodes 102A or 102B. Additionally, or alternatively, any one or more of the network nodes 102A or 102B may include one or more apparatuses 200 and/or one or more components of the apparatus 200. For example, in some aspects, the apparatus 200 may include an apparatus (e.g., a device, a device component, a modem, a chip, and/or a set of device components, among other examples) that is configured to perform a wireless communication method, as described herein. As shown in FIG. 2, the apparatus 200 may include components such as a bus 205, a processor 210, a memory 215, an input component 220, an output component 225, a communication interface 230, and a communication manager 235. Any one or more of the components 205, 210, 215, 220, 225 230, and/or 235 may be implemented in hardware, software, or a combination of hardware and software.

The bus 205 includes a component that permits communication among the components of the apparatus 200. The processor 210 includes a central processing unit (CPU), a graphics processing unit (GPU), an accelerated processing unit (APU), a digital signal processor (DSP), a microprocessor, a microcontroller, a field-programmable gate array (FPGA), an application-specific integrated circuit (ASIC), and/or another type of processing component. In some aspects, the processor 210 includes one or more processors capable of being programmed to perform a function.

The memory 215 includes a random-access memory (RAM), a read only memory (ROM), and/or another type of dynamic or static storage device (e.g., a flash memory, a magnetic memory, and/or an optical memory) that stores information and/or instructions for use by the processor 210. The memory 215 may store other information and/or software related to the operation and use of the apparatus 200. For example, the memory 215 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium.

The input component 220 includes a component that permits the apparatus 200 to receive information, such as via user input. For example, the input component 220 may be associated with a user interface as described herein (e.g., to permit a user to interact with the one or more features of the apparatus 200). The input component 220 may include a capacitive touchscreen display that can receive user inputs. The input component 220 may include a keyboard, a keypad, a mouse, a button, a switch, and/or a microphone, among other examples. Additionally, or alternatively, the input component 220 may include a sensor for sensing information (e.g., a vision sensor, a location sensor, an accelerometer, a gyroscope, and/or an actuator, among other examples). In some aspects, the input component 220 may include a camera (e.g., a high-resolution camera and/or a low-resolution camera, among other examples). The output component 225 may include a component that provides output from the apparatus 200 (e.g., a display, a speaker, and/or one or more light-emitting diodes (LEDs), among other examples).

The communication interface 230 may include a transmission component and/or a reception component. For example, the communication interface 230 may include a transceiver and/or one or more separate receivers and/or transmitters that enable the apparatus 200 to communicate with other devices, such as via a wired connection, a wireless connection, or a combination of wired and wireless connections.

In some aspects, the communication interface may include one or more radio frequency reflective elements and/or one or more radio frequency refractive elements. The communication interface 230 may permit the apparatus 200 to receive information from another apparatus and/or provide information to another apparatus. For example, the communication interface 230 may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

The communication manager 235 may include hardware, software, or a combination of hardware and software configured to cause the apparatus 200 to perform one or more communication tasks associated with the communication manager 106 and/or the transceiver 108. In some aspects, the communication manager 235 may be, be similar to, include, or be included in, the communication manager 106 depicted in FIG. 1. In some aspects, the communication manager 235 may include the processor 210, the memory 215, the input component 220, the output component 225, and/or the communication interface 230, and/or one or more aspects thereof.

As indicated above, FIG. 2 is provided as an example. Other examples may differ from what is described with regard to FIG. 2.

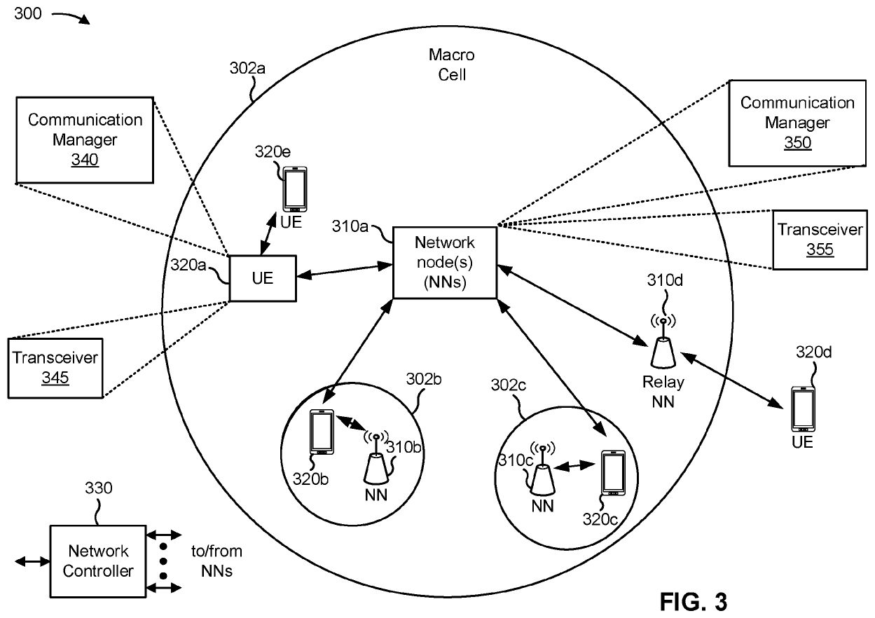

FIG. 3 is a diagram illustrating an example of a wireless network 300, in accordance with the present disclosure. The wireless network 300 may be or may include elements of a 5G (e.g., NR) network and/or a 4G (e.g., LTE) network, among other examples. The wireless network 300 may include one or more network nodes 310 (shown as a network node 310a, a network node 310b, a network node 310c, and a network node 310d), a UE 320 or multiple UEs 320 (shown as a UE 320a, a UE 320b, a UE 320c, a UE 320d, and a UE 320e), and/or other entities. A network node 310 is a network node that communicates with UEs 320. As shown, a network node 310 may include one or more network nodes. For example, a network node 310 may be an aggregated network node, meaning that the aggregated network node is configured to utilize a radio protocol stack that is physically or logically integrated within a single radio access network (RAN) node (e.g., within a single device or unit). As another example, a network node 310 may be a disaggregated network node (sometimes referred to as a disaggregated base station), meaning that the network node 310 is configured to utilize a protocol stack that is physically or logically distributed among two or more nodes (such as one or more CUs, one or more DUs, or one or more RUs).

In some examples, a network node 310 is or includes a network node that communicates with UEs 320 via a radio access link, such as an RU. In some examples, a network node 310 is or includes a network node that communicates with other network nodes 310 via a fronthaul link or a midhaul link, such as a DU. In some examples, a network node 310 is or includes a network node that communicates with other network nodes 310 via a midhaul link or a core network via a backhaul link, such as a CU. In some examples, a network node 310 (such as an aggregated network node 310 or a disaggregated network node 310) may include multiple network nodes, such as one or more RUs, one or more CUs, and/or one or more DUs. A network node 310 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 310 may be interconnected to one another or to one or more other network nodes 310 in the wireless network 300 through various types of fronthaul, midhaul, and/or backhaul interfaces, such as a direct physical connection, an air interface, or a virtual network, using any suitable transport network.

In some examples, a network node 310 may provide communication coverage for a particular geographic area. In the Third Generation Partnership Project (3GPP), the term “cell” can refer to a coverage area of a network node 310 and/or a network node subsystem serving this coverage area, depending on the context in which the term is used. A network node 310 may provide communication coverage for a macro cell, a pico cell, a femto cell, and/or another type of cell. A macro cell may cover a relatively large geographic area (e.g., several kilometers in radius) and may allow unrestricted access by UEs 320 with service subscriptions. A pico cell may cover a relatively small geographic area and may allow unrestricted access by UEs 320 with service subscriptions. A femto cell may cover a relatively small geographic area (e.g., a home) and may allow restricted access by UEs 320 having association with the femto cell (e.g., UEs 320 in a closed subscriber group (CSG)). A network node 310 for a macro cell may be referred to as a macro network node. A network node 310 for a pico cell may be referred to as a pico network node. A network node 310 for a femto cell may be referred to as a femto network node or an in-home network node. In the example shown in FIG. 3, the network node 310a may be a macro network node for a macro cell 302a, the network node 310b may be a pico network node for a pico cell 302b, and the network node 310c may be a femto network node for a femto cell 302c. A network node may support one or multiple (e.g., three) cells. In some examples, a cell may not necessarily be stationary, and the geographic area of the cell may move according to the location of a network node 310 that is mobile (e.g., a mobile network node).

In some aspects, the term “base station” or “network node” may refer to an aggregated base station, a disaggregated base station, an IAB node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 310. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 300 may include one or more relay stations. A relay station is a network node that can receive a transmission of data from an upstream node (e.g., a network node 310 or a UE 320) and send a transmission of the data to a downstream node (e.g., a UE 320 or a network node 310). A relay station may be a UE 320 that can relay transmissions for other UEs 320. In the example shown in FIG. 3, the network node 310d (e.g., a relay network node) may communicate with the network node 310a (e.g., a macro network node) and the UE 320d in order to facilitate communication between the network node 310a and the UE 320d. A network node 310 that relays communications may be referred to as a relay station, a relay base station, a relay network node, a relay node, a relay, or the like.

The wireless network 300 may be a heterogeneous network that includes network nodes 310 of different types, such as macro network nodes, pico network nodes, femto network nodes, relay network nodes, or the like. These different types of network nodes 310 may have different transmit power levels, different coverage areas, and/or different impacts on interference in the wireless network 300. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 330 may couple to or communicate with a set of network nodes 310 and may provide coordination and control for these network nodes 310. The network controller 330 may communicate with the network nodes 310 via a backhaul communication link or a midhaul communication link. The network nodes 310 may communicate with one another directly or indirectly via a wireless or wireline backhaul communication link. In some aspects, the network controller 330 may be a CU or a core network device, or may include a CU or a core network device.

For example, in some aspects, the wireless network 300 may be, include, or be included in a wireless backhaul network, sometimes referred to as an JAB network. In an IAB network, at least one network node (e.g., network node 310) may be an anchor base station that communicates with a core network via a wired backhaul link, such as a fiber connection. An anchor base station may also be referred to as an IAB donor (or IAB-donor), a central entity, a central unit, and/or the like. An JAB network may include one or more non-anchor base stations, sometimes referred to as relay base stations or JAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 320) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target wireless node (e.g., a UE and/or a base station). In this way, inter-link interference may be reduced.

An IAB network may include an IAB donor that connects to a core network via a wired connection (e.g., a wireline backhaul). For example, an Ng interface of an IAB donor may terminate at a core network. Additionally, or alternatively, an IAB donor may connect to one or more devices of the core network that provide a core access and mobility management function (AMF). In some aspects, an IAB donor may include a base station, such as an anchor base station. An IAB donor may include a CU, which may perform access node controller (ANC) functions and/or AMF functions.

The CU may configure a DU of the IAB donor and/or may configure one or more IAB nodes (e.g., a mobile termination (MT) function and/or a DU function of an IAB node) that connect to the core network via the IAB donor. Thus, a CU of an IAB donor may control and/or configure the entire IAB network (or a portion thereof) that connects to the core network via the IAB donor, such as by using control messages and/or configuration messages (e.g., an RRC configuration message or an F1 application protocol (F1AP) message).

The MT functions of an IAB node (e.g., a child node) may be controlled and/or scheduled by another IAB node (e.g., a parent node of the child node) and/or by an IAB donor. The DU functions of an IAB node (e.g., a parent node) may control and/or schedule other IAB nodes (e.g., child nodes of the parent node) and/or UEs 320. Thus, a DU may be referred to as a scheduling node or a scheduling component, and an MT may be referred to as a scheduled node or a scheduled component. In some aspects, an IAB donor may include DU functions and not MT functions. That is, an IAB donor may configure, control, and/or schedule communications of IAB nodes and/or UEs 320. A UE 320 may include only MT functions, and not DU functions. That is, communications of a UE 320 may be controlled and/or scheduled by an IAB donor and/or an IAB node (e.g., a parent node of the UE 320).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor or an IAB node, and a child node may be an IAB node or a UE 320. Communications of an MT function of a child node may be controlled and/or scheduled by a parent node of the child node.

A link between a UE 320 and an IAB donor, or between a UE 320 and an IAB node, may be referred to as an access link. An access link may be a wireless access link that provides a UE 320 with radio access to a core network via an IAB donor, and optionally via one or more IAB nodes. Thus, the wireless network 300 may be referred to as a multi-hop network or a wireless multi-hop network.

A link between an IAB donor and an JAB node or between two IAB nodes may be referred to as a backhaul link. A backhaul link may be a wireless backhaul link that provides an IAB node with radio access to a core network via an IAB donor, and optionally via one or more other JAB nodes. In an IAB network, network resources for wireless communications (e.g., time resources, frequency resources, and/or spatial resources) may be shared between access links and backhaul links. In some aspects, a backhaul link may be a primary backhaul link or a secondary backhaul link (e.g., a backup backhaul link). In some aspects, a secondary backhaul link may be used if a primary backhaul link fails, becomes congested, and/or becomes overloaded, among other examples.

The UEs 320 may be dispersed throughout the wireless network 300, and each UE 320 may be stationary or mobile. A UE 320 may include, for example, an access terminal, a terminal, a mobile station, and/or a subscriber unit. A UE 320 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 320 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 320 may be considered Internet-of-Things (IoT) devices, and/or may be implemented as NB-IoT (narrowband IoT) devices. Some UEs 320 may be considered a Customer Premises Equipment. A UE 320 may be included inside a housing that houses components of the UE 320, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 300 may be deployed in a given geographic area. Each wireless network 300 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 320 (e.g., shown as UE 320a and UE 320e) may communicate directly using one or more sidelink channels (e.g., without using a network node 310 as an intermediary to communicate with one another). For example, the UEs 320 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 320 may perform scheduling operations, resource selection operations, and/or other operations described elsewhere herein as being performed by the network node 310.

Devices of the wireless network 300 may communicate using the electromagnetic spectrum, which may be subdivided by frequency or wavelength into various classes, bands, channels, or the like. For example, devices of the wireless network 300 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FRI and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FRI characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz −71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described above, in some aspects, a network node (e.g., the network node 102A and/or 102B depicted in FIG. 1) may be implemented in a wireless communication environment. For example, in some aspects, the network node may be implemented as a UE, a base station, relay device, and/or TRP, among other examples. In some such aspects, as shown in FIG. 3, the UE 320a may include a communication manager 340 and/or a transceiver 345 and the network node 310a may include a communication manager 350 and/or a transceiver 355. In some aspects, the communication manager 340 and/or 350 may be, be similar to, include, or be included in, the communication manager 106 depicted in FIG. 1 and/or the communication manager 235 depicted in FIG. 2. In some aspects, the transceiver 345 and/or 355 may be, be similar to, include, or be included in, the transceiver 108 depicted in FIG. 1. In some aspects, the transceiver 345 and/or 355 may include, or be included in, the communication interface 230 depicted in FIG. 2.

In some aspects, the network node may include a communication manager 340 and/or 350. As described in more detail elsewhere herein, the communication manager 340 and/or 350 may receive configuration information indicative of a plurality of semi-persistent communication configurations, wherein each semi-persistent communication configuration corresponds to a respective configuration index of a plurality of configuration indexes; receive a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and communicate based on the set of semi-persistent communication configurations.

In some aspects, the communication manager 340 and/or 350 may transmit configuration information indicative of a plurality of semi-persistent communication configurations, wherein each semi-persistent communication configuration corresponds to a respective configuration index of a plurality of configuration indexes; transmit a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and communicate based on the set of semi-persistent communication configurations.

In some aspects, the communication manager 340 and/or 350 may receive configuration information indicative of a plurality of semi-persistent communication configurations, wherein each semi-persistent communication configuration corresponds to a respective configuration index of a plurality of configuration indexes; and receive a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

In some aspects, the communication manager 340 and/or 350 may transmit configuration information indicative of a plurality of semi-persistent communication configurations, wherein each semi-persistent communication configuration corresponds to a respective configuration index of a plurality of configuration indexes; and transmit a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations. Additionally, or alternatively, the communication manager 340 and/or 350 may perform one or more other operations described herein.

As indicated above, FIG. 3 is provided as an example. Other examples may differ from what is described with regard to FIG. 3.

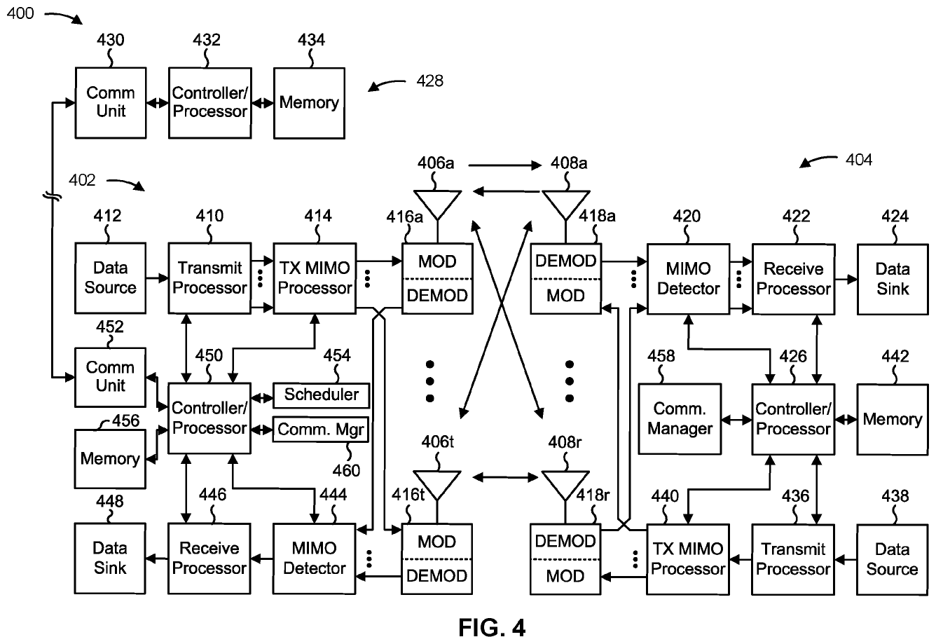

FIG. 4 is a diagram illustrating an environment 400 including a network node 402 in wireless communication with a network node 404 (e.g., via a network such as the network 104 depicted in FIG. 1 and/or the wireless network 300 depicted in FIG. 3), in accordance with the present disclosure. The network node 402 may be equipped with a set of antennas 406a through 406t, such as T antennas (T≥1). The network node 404 may be equipped with a set of antennas 408a through 408r, such as R antennas (R≥1).

At the network node 402, a transmit processor 410 may receive data, from a data source 412, intended for the network node 404 (or a set of network nodes 404). The transmit processor 410 may select one or more modulation and coding schemes (MCSs) for the network node 404 based on one or more channel quality indicators (CQIs) received from that network node 404. The network node 402 may process (e.g., encode and modulate) the data for the network node 404 based on the MCS(s) selected for the network node 404 and may provide data symbols for the network node 404. The transmit processor 410 may process system information (e.g., for semi-static resource partitioning information (SRPI)) and control information (e.g., CQI requests, grants, and/or upper layer signaling) and provide overhead symbols and control symbols. The transmit processor 410 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 414 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 416a through 416t (e.g., T modems). For example, each output symbol stream may be provided to a modulator component (shown as MOD) of a modem of the set of modems 416a through 416t. Each modem of the set of modems 416a through 416t may use a respective modulator component to process a respective output symbol stream (e.g., for OFDM) to obtain an output sample stream. Each modem of the set of modems 416a through 416t may further use a respective modulator component to process (e.g., convert to analog, amplify, filter, and/or upconvert) the output sample stream to obtain a signal. One or more modems of the set of modems 416a through 416t may transmit a set of signals (e.g., T signals) via a corresponding antenna of the set of antennas 406a through 406t. The signal may include, for example, a downlink signal.

At the network node 404, one or more antennas of the set of antennas 408a through 408r may receive the signals from the network node 402 and/or network nodes and may provide a set of received signals (e.g., R received signals) to one or more modems of a set of modems 418a through 418r (e.g., R modems). For example, each received signal may be provided to a demodulator component (shown as DEMOD) of a respective modem of the set of modems 418a through 418r. Each modem of the set of modems 418a through 418r may use a respective demodulator component to condition (e.g., filter, amplify, downconvert, and/or digitize) a received signal to obtain input samples. Each modem of the set of modems 418a through 418r may use a demodulator component to further process the input samples (e.g., for OFDM) to obtain received symbols. A MIMO detector 420 may obtain received symbols from one or more modems of the set of modems 418a through 418r, may perform MIMO detection on the received symbols if applicable, and may provide detected symbols.

A receive processor 422 may process (e.g., demodulate and decode) the detected symbols, may provide decoded data for the network node 404 to a data sink 424, and may provide decoded control information and system information to a controller/processor 426. The term “controller/processor” may refer to one or more controllers, one or more processors, or a combination thereof. The controller/processor 426 may be, be similar to, include, or be included in, the processor 210 depicted in FIG. 2. The controller/processor 426 may determine a reference signal received power (RSRP) parameter, a received signal strength indicator (RSSI) parameter, a reference signal received quality (RSRQ) parameter, and/or a CQI parameter, among other examples.

A network controller 428 may include a communication unit 430, a controller/processor 432, and a memory 434. The network controller 428 may be, be similar to, include, or be included in, the network controller 330 depicted in FIG. 3. The network controller 428 may include, for example, one or more devices in a core network. The network controller 428 may communicate with the network node 402 via the communication unit 430.

One or more antennas (e.g., antennas 406a through 406t and/or antennas 408a through 408r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 4.

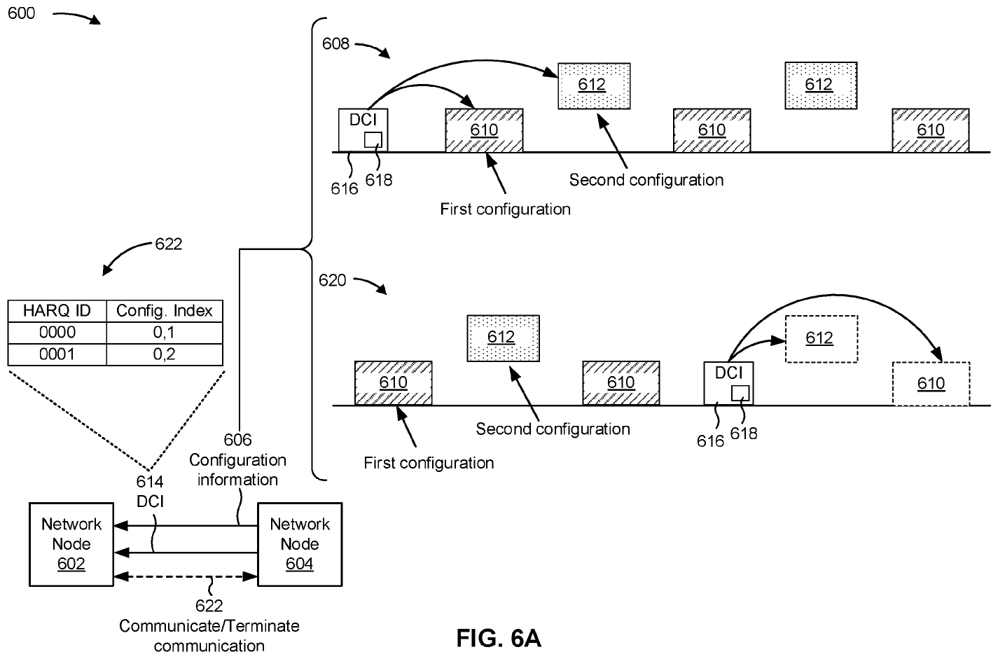

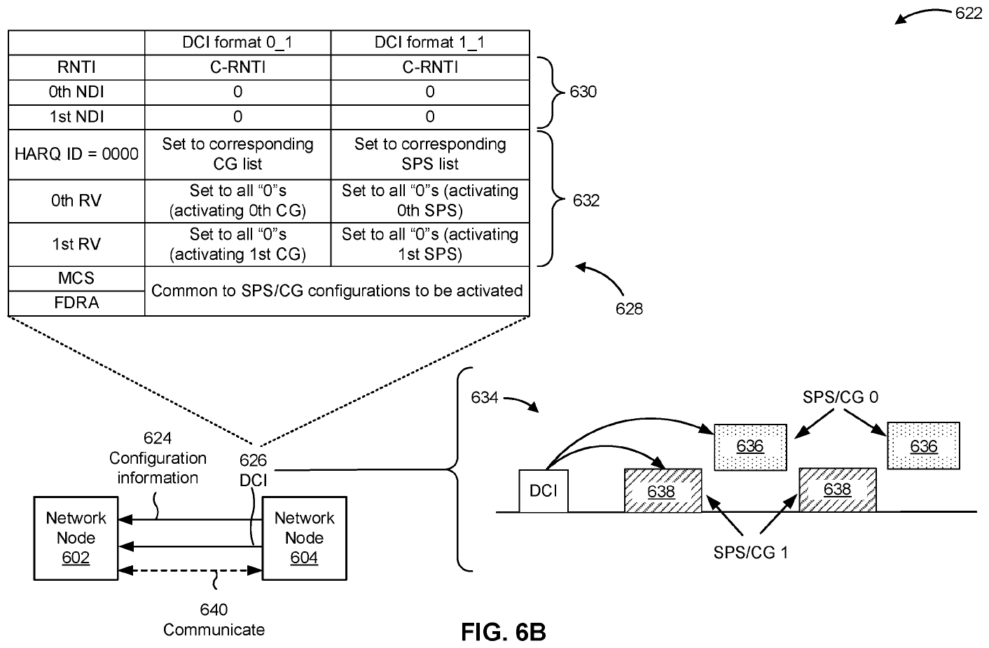

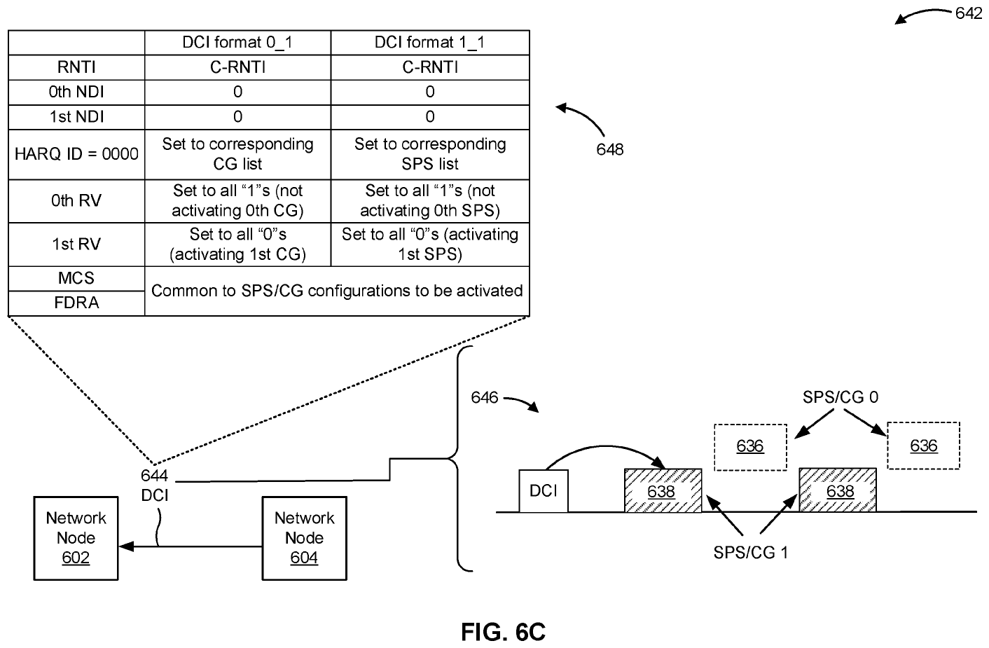

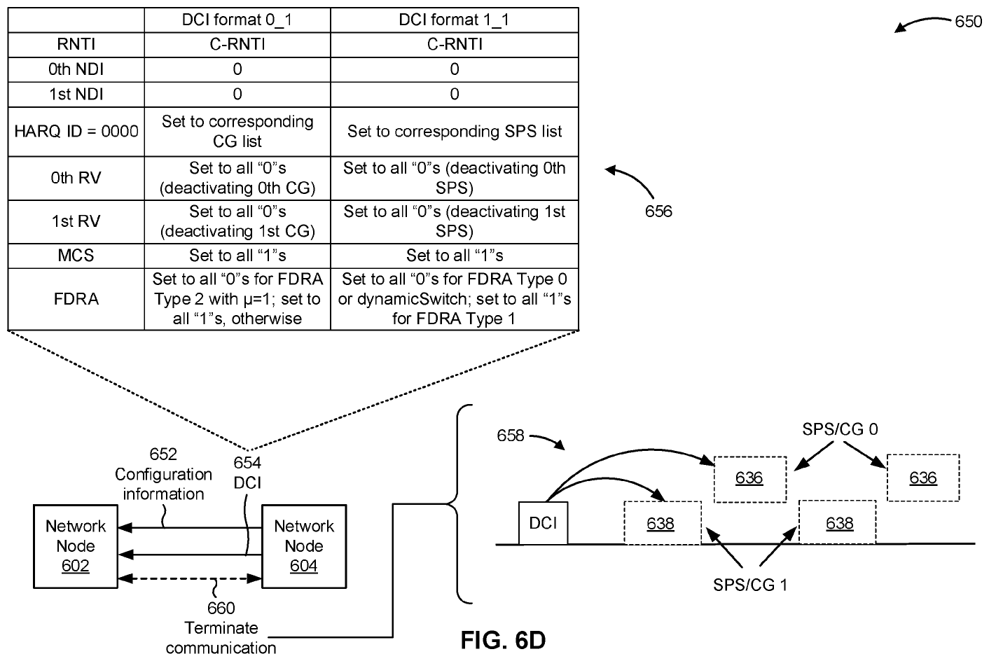

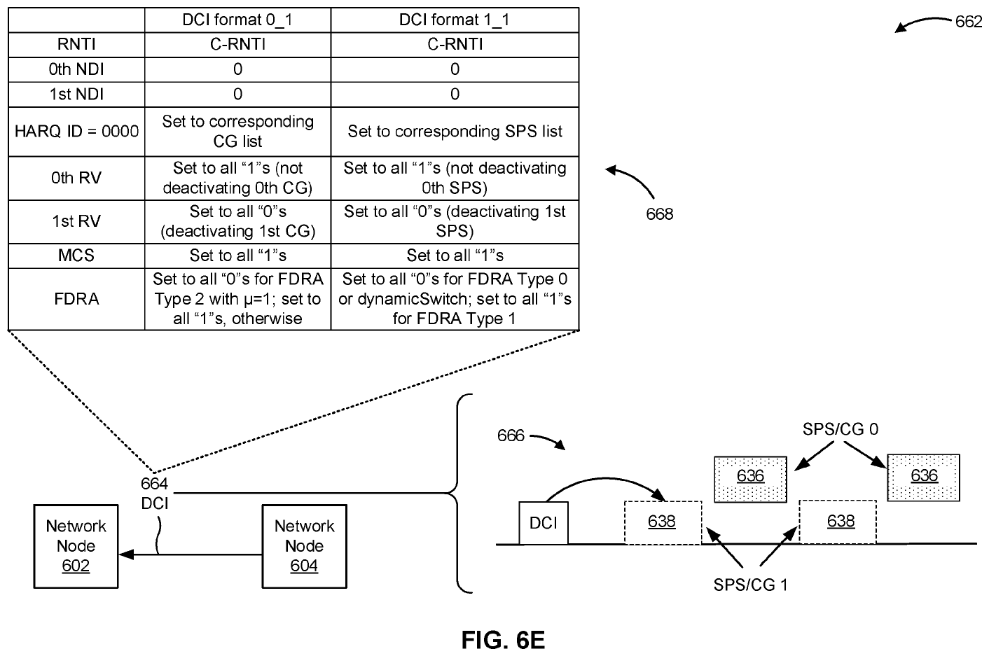

Similarly, at the network node 404, a transmit processor 436 may receive and process data from a data source 438 and control information (e.g., for reports that include RSRP, RSSI, RSRQ, and/or CQI) from the controller/processor 426. The transmit processor 436 may generate reference symbols for one or more reference signals. The symbols from the transmit processor 436 may be precoded by a TX MIMO processor 440 if applicable, and further processed by one or more of the set of modems 418a through 418r (e.g., for DFT-s-OFDM or CP-OFDM), and transmitted to the network node 402. In some examples, each modem of the set of modems 418a through 418r of the network node 404 may include a modulator and a demodulator. In some examples, the network node 404 includes a transceiver. The transceiver may include any combination of the antenna(s) 408a through 408r, the modem(s) 418a through 418r, the MIMO detector 420, the receive processor 422, the transmit processor 436, and/or the TX MIMO processor 440. The transceiver may be, be similar to, include, or be included in, the transceiver 108 depicted in FIG. 1 and/or the communication interface 230 depicted in FIG. 2. The transceiver may be used by a processor (e.g., the controller/processor 426) and/or a memory 442 to perform aspects of any of the methods described herein (e.g., with reference to FIGS. 6A-15).

At the network node 402, the signals from network node 404 and/or other network nodes may be received by one or more antennas of the set of antennas 406a through 406t, processed by one or more modems of the set of modems 416a through 416t (e.g., a demodulator component, shown as DEMOD), detected by a MIMO detector 444 if applicable, and further processed by a receive processor 446 to obtain decoded data and control information sent by the network node 404. The receive processor 446 may provide the decoded data to a data sink 448 and provide the decoded control information to a controller/processor 450. The network node 402 may include a communication unit 452 and may communicate with the network controller 428 via the communication unit 452. The network node 402 may include a scheduler 454 to schedule one or more network nodes 404 for downlink and/or uplink communications.

In some examples, one or more modems of the set of modem 416a through 416t of the network node 402 may include a modulator and a demodulator. In some examples, the network node 402 includes a transceiver. The transceiver may include any combination of the antenna(s) 406a through 406t, the modem(s) 416a through 416t, the MIMO detector 444, the receive processor 446, the transmit processor 410, and/or the TX MIMO processor 414. The transceiver may be, be similar to, include, or be included in, the transceiver 108 depicted in FIG. 1 and/or the communication interface 230 depicted in FIG. 2. The transceiver may be used by a processor (e.g., the controller/processor 450) and a memory 456 to perform aspects of any of the methods described herein (e.g., with reference to FIGS. 6A-15).

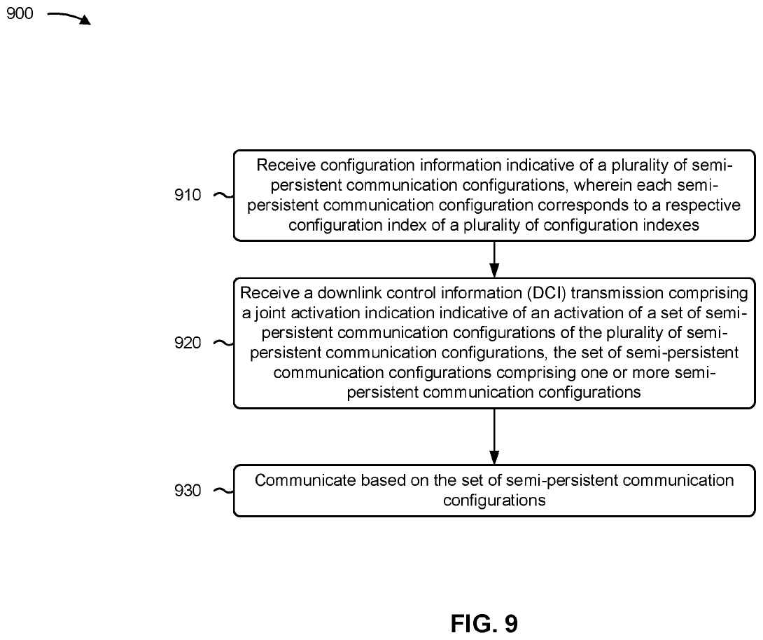

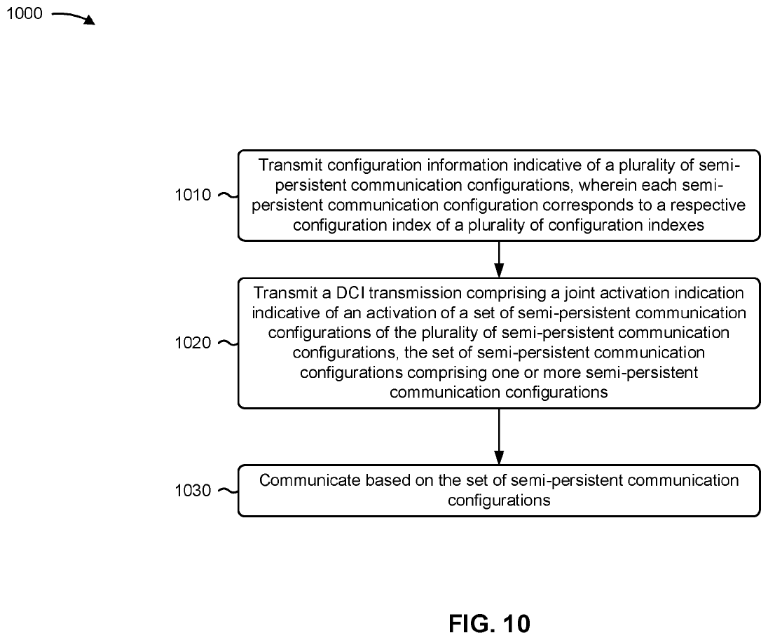

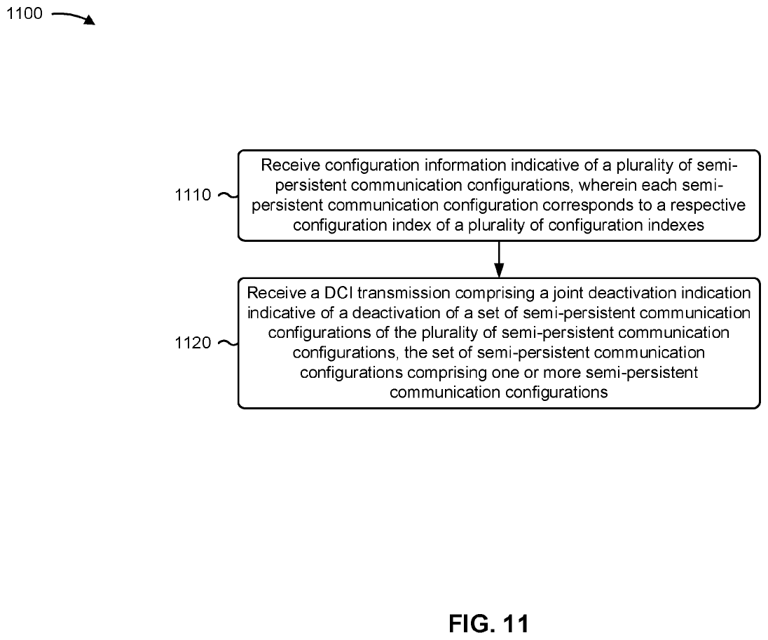

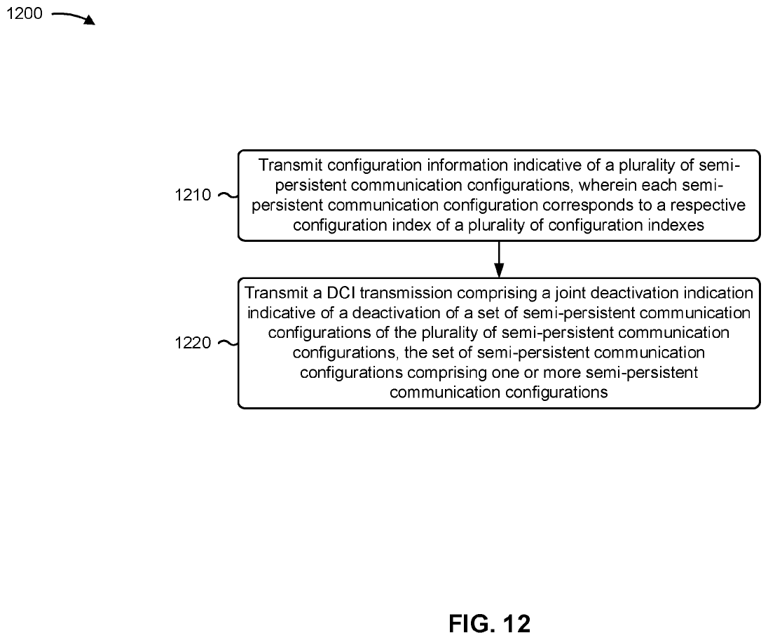

The controller/processor 450 of the network node 402, the controller/processor 426 of the network node 404, and/or any other component(s) of FIG. 4 may perform one or more techniques associated with joint activation and/or deactivation DCI associated with multiple semi-persistent communication configurations, as described in more detail elsewhere herein. For example, the controller/processor 450 of the network node 402, the controller/processor 426 of the network node 404, and/or any other component(s) of FIG. 4 may perform or direct operations of, for example, process 900 of FIG. 9, process 1000 of FIG. 10, process 1100 of FIG. 11, process 1200 of FIG. 12, and/or other processes as described herein. The memory 442 and the memory 456 may store data and program codes for the network node 402 and the network node 404, respectively. In some examples, the memory 442 and/or the memory 456 may include a non-transitory computer-readable medium storing one or more instructions (e.g., code and/or program code) for wireless communication. For example, the one or more instructions, when executed (e.g., directly, or after compiling, converting, and/or interpreting) by one or more respective processors of the network node 402 and/or the network node 404, may cause the one or more processors, the network node 404, and/or the network node 402 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the network node 404 may include a communication manager 458 and the network node 402 may include a communication manager 460. The communication managers 458 and 460 may be implemented, in some aspects, via the one or more respective processors of the network node 404 and/or the network node 402 (e.g., via execution of computer-readable instructions). The communication managers 458 and 460 may include any one or more of the other components of the network nodes 404 and 402, respectively. In some aspects, the communication manager 458 and/or the communication manager 460 may be, be similar to, include, or be included in, the communication manager 340 and/or the communication manager 350, depicted in FIG. 3, the communication manager 235 depicted in FIG. 2, and/or the communication manager 106 depicted in FIG. 1.

In some aspects, a network node includes means for receiving configuration information indicative of a plurality of semi-persistent communication configurations, wherein each semi-persistent communication configuration corresponds to a respective configuration index of a plurality of configuration indexes; means for receiving a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and/or means for communicating based on the set of semi-persistent communication configurations.

In some aspects, the network node includes means for transmitting, configuration information indicative of a plurality of semi-persistent communication configurations, wherein each semi-persistent communication configuration corresponds to a respective configuration index of a plurality of configuration indexes; means for transmitting a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and/or means for communicating based on the set of semi-persistent communication configurations.

In some aspects, the network node includes means for receiving configuration information indicative of a plurality of semi-persistent communication configurations, wherein each semi-persistent communication configuration corresponds to a respective configuration index of a plurality of configuration indexes; and/or means for receiving a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

In some aspects, the network node includes means for transmitting configuration information indicative of a plurality of semi-persistent communication configurations, wherein each semi-persistent communication configuration corresponds to a respective configuration index of a plurality of configuration indexes; and/or means for transmitting a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations. In some aspects, the means for the network node to perform operations described herein may include, for example, one or more of communication manager 460, transmit processor 410, TX MIMO processor 414, modem 416, antenna 406, MIMO detector 444, receive processor 446, controller/processor 450, memory 456, or scheduler 454. In some aspects, the means for the network node to perform operations described herein may include, for example, one or more of communication manager 458, antenna 408, modem 418, MIMO detector 420, receive processor 422, transmit processor 436, TX MIMO processor 440, controller/processor 426, or memory 442.

While blocks in FIG. 4 are illustrated as distinct components, the functions described above with respect to the blocks may be implemented in a single hardware, software, or combination component or in various combinations of components. For example, the functions described with respect to the transmit processor 436, the receive processor 422, and/or the TX MIMO processor 440 may be performed by or under the control of the controller/processor 426. Any number of other combination of various combinations of components depicted in FIG. 4 may be considered to be within the ambit of the present disclosure.

As indicated above, FIG. 4 is provided as an example. Other examples may differ from what is described with regard to FIG. 4.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

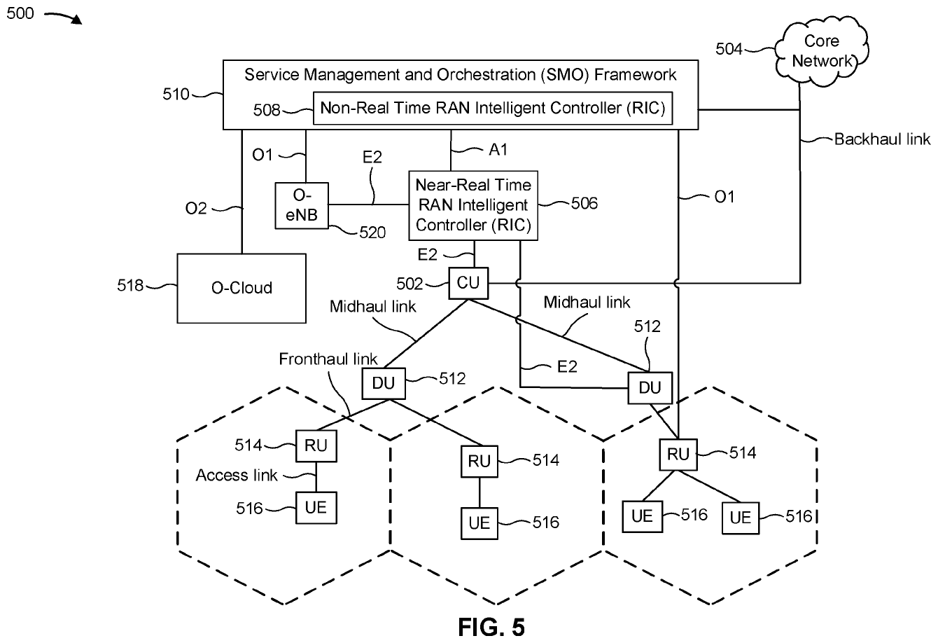

FIG. 5 is a diagram illustrating an example disaggregated base station architecture 500, in accordance with the present disclosure. The disaggregated base station architecture 500 may include a CU 502 that can communicate directly with a core network 504 via a backhaul link, or indirectly with the core network 504 through one or more disaggregated control units (such as a Near-RT RIC 506 via an E2 link, or a Non-RT RIC 508 associated with a Service Management and Orchestration (SMO) Framework 510, or both). A CU 502 may communicate with one or more DUs 512 via respective midhaul links, such as through Fl interfaces. Each of the DUs 512 may communicate with one or more RUs 514 via respective fronthaul links. Each of the RUs 514 may communicate with one or more UEs 516 via respective RF access links. In some implementations, a UE 516 may be simultaneously served by multiple RUs 514.

Each of the units, including the CU 502, the DUs 512, the RUs 514, as well as the Near-RT RICs 506, the Non-RT RICs 508, and the SMO Framework 510, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 502 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 502. The CU 502 may be configured to handle user plane functionality (for example, Central Unit—User Plane (CU-UP) functionality), control plane functionality (for example, Central Unit—Control Plane (CU-CP) functionality), or a combination thereof. In some implementations, the CU 502 can be logically split into one or more CU-UP units and one or more CU-CP units. A CU-UP unit can communicate bidirectionally with a CU-CP unit via an interface, such as the E1 interface when implemented in an O-RAN configuration. The CU 502 can be implemented to communicate with a DU 512, as necessary, for network control and signaling.

Each DU 512 may correspond to a logical unit that includes one or more base station functions to control the operation of one or more RUs 514. In some aspects, the DU 512 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 512 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 512, or with the control functions hosted by the CU 502.

Each RU 514 may implement lower-layer functionality. In some deployments, an RU 514, controlled by a DU 512, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 514 can be operated to handle over the air (OTA) communication with one or more UEs 516. In some implementations, real-time and non-real-time aspects of control and user plane communication with the RU(s) 514 can be controlled by the corresponding DU 512. In some scenarios, this configuration can enable each DU 512 and the CU 502 to be implemented in a cloud-based RAN architecture, such as a vRAN architecture.

The SMO Framework 510 may be configured to support RAN deployment and provisioning of non-virtualized and virtualized network elements. For non-virtualized network elements, the SMO Framework 510 may be configured to support the deployment of dedicated physical resources for RAN coverage requirements, which may be managed via an operations and maintenance interface (such as an O1 interface). For virtualized network elements, the SMO Framework 510 may be configured to interact with a cloud computing platform (such as an open cloud (O-Cloud) platform 518) to perform network element life cycle management (such as to instantiate virtualized network elements) via a cloud computing platform interface (such as an O2 interface). Such virtualized network elements can include, but are not limited to, CUs 502, DUs 512, RUs 514, Near-RT RICs 506, and non-RT RICs 508. In some implementations, the SMO Framework 510 can communicate with a hardware aspect of a 4G RAN, such as an open eNB (O-eNB) 520, via an O1 interface. Additionally, in some implementations, the SMO Framework 510 can communicate directly with each of one or more RUs 514 via a respective O1 interface. The SMO Framework 510 also may include a Non-RT RIC 508 configured to support functionality of the SMO Framework 510.

The Non-RT RIC 508 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 506.

The Non-RT RIC 508 may be coupled to or communicate with (such as via an Al interface) the Near-RT RIC 506. The Near-RT RIC 506 may be configured to include a logical function that enables near-real-time control and optimization of RAN elements and resources via data collection and actions over an interface (such as via an E2 interface) connecting one or more CUs 502, one or more DUs 512, or both, as well as an O-eNB 520, with the Near-RT RIC 506.

In some implementations, to generate AI/ML models to be deployed in the Near-RT RIC 506, the Non-RT RIC 508 may receive parameters or external enrichment information from external servers. Such information may be utilized by the Near-RT RIC 506 and may be received at the SMO Framework 510 or the Non-RT RIC 508 from non-network data sources or from network functions. In some examples, the Non-RT RIC 508 or the Near-RT RIC 506 may be configured to tune RAN behavior or performance. For example, the Non-RT RIC 508 may monitor long-term trends and patterns for performance and employ AI/ML models to perform corrective actions through the SMO Framework 510 (such as reconfiguration via an O1 interface) or via creation of RAN management policies (such as Al interface policies).

Any one or more of the components of the disaggregated base station architecture 500 may be used to implement one or more aspects of the techniques described herein.

As indicated above, FIG. 5 is provided as an example. Other examples may differ from what is described with respect to FIG. 5.

FIG. 6A is a diagram illustrating an example 600 associated with joint activation and/or deactivation DCI associated with multiple semi-persistent communication configurations, in accordance with the present disclosure. As shown, example 600 includes a network node 602 and a network node 604 in communication with one another. In some aspects, the network node 602 and/or the network node 604 may be, be similar to, include, or be included in, one or more of the components of the disaggregated base station architecture 500 depicted in FIG. 5, the network node 402 and/or the network node 404 depicted in FIG. 4, the network node 310 and/or the UE 320 depicted in FIG. 3, the apparatus 200 depicted in FIG. 2, and/or the network node 102A and/or the network node 102B depicted in FIG. 1.

As shown by reference number 606, the network node 604 may transmit, and the network node 602 may receive, configuration information. For example, the network node 602 may receive the configuration information via an RRC message transmitted by the network node 604. The configuration information may be indicative of a plurality of semi-persistent communication configurations. Each semi-persistent communication configuration may correspond to a respective configuration index. In some aspects, the semi-persistent communication configurations may include SPS configurations and/or CG configurations. SPS configurations may be associated with downlink communications and CG configurations may be associated with uplink communications. Once activated, SPS communications may include periodic downlink communications that are configured for the network node 602, by the network node 604, such that the network node 604 does not need to send separate DCI to schedule each downlink communication, thereby conserving signaling overhead. Once activated, CG communications may include periodic uplink communications that are configured for the network node 602, such that the network node 604 does not need to send separate DCI to schedule each uplink communication, thereby conserving signaling overhead. For example, as shown by reference number 608, the plurality of semi-persistent communication configurations may include a first configuration that includes a set of recurring scheduled semi-persistent occasions 610 and a second configuration that includes a set of recurring scheduled semi-persistent occasions 612.

An SPS configuration may indicate a periodicity resulting in periodically reoccurring scheduled SPS occasions for the network node 602. The first SPS configuration may be associated with a first channel and the second SPS configuration may be associated with a second channel. The first channel and second channel may be physical channels. In frequency division duplexing (FDD) mode, a physical channel refers to a specified code, frequency and, in the uplink, relative phase (I/Q). In time division duplexing (TDD) mode, a physical channel refers to a specified code, frequency, and time-slot. For example, in some aspects, the first channel may include a first data channel such as a physical downlink shared channel (PDSCH) and the second channel may include a second data channel such as a PDSCH. The first PDSCH and the second PDSCH may be associated with different frequency resources and/or time resources.

The SPS configuration may also configure hybrid automatic repeat request (HARQ)-acknowledgement (ACK) (HARQ-ACK) feedback resources for the network node 602 to transmit HARQ-ACK feedback for SPS PDSCH communications received in the scheduled occasions 610 or 612. For example, the SPS configuration may indicate a PDSCH-to-HARQ feedback timing value, which may be referred to as a K1 value in a wireless communication standard (e.g., a 3GPP standard).

A CG configuration may indicate a periodicity resulting in periodically reoccurring scheduled CG occasions (e.g., the semi-persistent communication occasions 610 and/or 612) for the network node 602. In some examples, the CG configuration may identify a resource pool or multiple resource pools that are available to the network node 602 for an uplink transmission. The CG configuration may configure contention-free CG communications (e.g., where resources are dedicated for the network node 602 to transmit uplink communications) or contention-based CG communications (e.g., where the network node 602 contends for access to a channel in the configured resource allocation, such as by using a channel access procedure or a channel sensing procedure).

As shown by reference number 614, the network node 604 may transmit, and the network node 602 may receive a DCI transmission 616. The DCI transmission 616 may include a joint activation indication 618 indicative of an activation of a set of semi-persistent communication configurations of the plurality of semi-persistent communication configurations. The set of semi-persistent communication configurations may include one or more of the plurality of semi-persistent communication configurations. The joint activation indication 618 may activate and/or deactivate the indicated semi-persistent communication configurations.

For example, as shown by a schematic representation 608 of activation by a joint activation DCI (“DCI”) of two semi-persistent communication configurations (“First configuration” and “Second configuration”), the joint activation DCI transmission 616 may activate a first configuration (associated with communication occasions 610) and a second configuration (associated with communication occasions 612). In some aspects, the joint activation DCI transmission 616 may activate only one of the first or second configurations. As shown by a schematic representation 620 of deactivation (e.g., later in time than the activation shown by the schematic representation 608), the joint activation DCI transmission 616 may deactivate the first configuration and the second configuration. In some aspects, the joint activation DCI transmission 616 may deactivate only one of the first or second configurations.

The network node 604 may indicate, in the joint activation DCI 616, communication parameters, such as a resource allocation associated with SPS or CG communications (e.g., in a time domain, frequency domain, spatial domain, and/or code domain), a modulation and coding scheme (MCS), a resource block (RB) allocation, and/or antenna ports, among other examples. The communication parameters may be used to facilitate communications in the scheduled semi-persistent communication occasions 610 and/or 612. In example 600, the single joint activation DCI 616 activates multiple SPS or multiple CG communications using a DCI format that can schedule multiple PDSCH or multiple PUSCH communications. That is, the single activation DCI 616 defines a set of resources for multiple SPS or multiple CG communications. The single activation DCI 616 may indicate a time domain resource allocation which include a set of time domain resources such that a separate start and length indicator value (SLIV), mapping type, and offset K0 are applied for each SPS or each CG communications to determine the time resource of a corresponding SPS or CG occasion. Each SPS and/or CG occasion may have an individual and separate transport block (TB). The bits of a redundancy version (RV) field (that is, an RV identifier (RVID)) and a new data indicator (NDI) field, respectively, in the single activation DCI transmission may be one-to-one mapped to the SPS or CG communications in the scheduled order. For example, the least significant bits of the RV field and NDI field, respectively, correspond to the last SPS or CG activated by the DCI.

In some aspects, some indication in the activation DCI 616 is common to all the activated SPS or CG communications, rather than per SPS or per CG. For example, frequency domain resource allocation, one modulation and coding scheme (MCS), precoding indication, demodulation reference signal, transmission configuration indicator, may be signalled (via the DCI transmission) for all of the SPS or CG communications

In some aspects, the multiple SPS or CG communications in a joint activation and/or deactivation indication 618 may be associated with a HARQ ID. For example, example 600 illustrates a portion 622 of the DCI transmission 616 that includes two HARQ ID fields showing example HARQ IDs 0000 and 0001. Each of the HARQ ID fields is associated with a set of configuration indexes associated with one or more semi-persistent communication configurations. For example, the HARQ ID 0000 is associated with configuration index 0,1 and the HARQ ID 0001 is associated with configuration index 0,2. In some aspects, the configuration information may include a semi-persistent communication configuration activation state set that includes the plurality of semi-persistent communication configurations, and the joint activation and/or deactivation indication may include a value of a HARQ process number field of the DCI transmission. In some aspects, the semi-persistent communication configuration activation state set may include a CG configuration deactivation state list and/or an SPS configuration deactivation state list. In this way, joint activation may be indicated using existing parameters, thereby reducing control signal overhead. In some aspects, the semi-persistent communication configuration activation state set may include a configured grant configuration activation state list that is different from a CG configuration deactivation state list and/or an SPS configuration activation state list that is different from a semi-persistent scheduling configuration deactivation state list.

In some aspects, the DCI transmission may have a multi-shared channel DCI format, and the joint activation and/or deactivation indication may include a HARQ ID field. The HARQ ID field may indicate a HARQ ID value corresponding to the set of semi-persistent communication configurations. In some aspects, the network node 602 may be activated with all or a subset of N SPS configurations and/or CG configurations associated with the HARQ ID. For example, the HARQ ID value may correspond to at least one additional semi-persistent communication configuration that is excluded from the set of semi-persistent communication configurations. In some aspects, the DCI transmission may indicate at least one common parameter value associated with the set of semi-persistent communication configurations.

As shown by reference number 622, the network node 602 and the network node 604 may communicate based at least in part on the activated set of semi-persistent communication configurations or may terminate communications associated with the set of semi-persistent communication configurations. In some aspects, communicating may include communicating XR information.

As indicated above, FIG. 6A is provided as an example. Other examples may differ from what is described with regard to FIG. 6A.

FIG. 6B is a diagram illustrating an example 622 of joint activation DCI associated with multiple semi-persistent communication configurations, in accordance with the present disclosure. As shown, example 622 includes the network node 602 and the network node 604 in communication with one another.

As shown by reference number 624, the network node 604 may transmit, and the network node 602 may receive, configuration information. As explained in connection with FIG. 6A, the configuration information may be indicative of a plurality of semi-persistent communication configurations. Each semi-persistent communication configuration may correspond to a respective configuration index of a plurality of configuration indexes.

As shown by reference number 626, the network node 604 may transmit, and the network node 602 may receive, a DCI transmission. The DCI transmission may include a joint activation indicative of an activation of a set of semi-persistent communication configurations of the plurality of semi-persistent communication configurations. The set of semi-persistent communication configurations may include one or more semi-persistent communication configurations.

In some aspects, the configuration information may include a semi-persistent communication configuration activation state set that includes the plurality of semi-persistent communication configurations, and the joint activation indication may include a value of a HARQ process number field of the DCI transmission. For example, if the network node 602 is provided with a ConfiguredGrantConfigType2ActivationStateList or a sps-ConfigActivationStateList, a value of the HARQ process number field in the DCI transmission may indicate a corresponding entry for activating one or more uplink grant Type 2 PUSCH configurations or SPS PDSCH configurations, when the DCI is validated as for CG or SPS activation.

In some aspects, the semi-persistent communication configuration activation state set may include a CG configuration deactivation state list and/or an SPS configuration deactivation state list. For example, in some aspects, a ConfiguredGrantConfigType2ActivationStateList may be a reused ConfiguredGrantConfigType2DectivationStateList, and an sps-ConfigActivationStateList may be a reused sps-ConfigDectivationStateList. In this way, joint activation may be indicated using existing parameters, thereby reducing control signal overhead. In some aspects, the semi-persistent communication configuration activation state set may include a configured grant configuration activation state list that is different from a CG configuration deactivation state list and/or an SPS configuration activation state list that is different from a semi-persistent scheduling configuration deactivation state list.

In some aspects, as shown by the table 628 in FIG. 6B, the DCI transmission may have a multi-shared channel DCI format (e.g., DCI format 0_1 or DCI format 1_1). The DCI format may include a set 630 of validation fields for validating the DCI transmission and a set 632 of parameter fields for individual control of activation for N semi-persistent communication configurations associated with a HARQ ID (e.g., the HARQ ID 0000). As shown, the joint activation indication may include a HARQ ID field. The HARQ ID field may indicate a HARQ ID value corresponding to the set of N semi-persistent communication configurations. In some aspects, the network node 602 may be activated with all or a subset of N SPS configurations and/or CG configurations associated with the HARQ ID. For example, the HARQ ID value may correspond to at least one additional semi-persistent communication configuration that is excluded from the set of semi-persistent communication configurations.

In some aspects, the DCI transmission may include a time domain resource allocation (TDRA) field that indicates a set of TDRA entries associated with the set of semi-persistent communication configurations. The TDRA field may indicate the set of TDRA entries based on a time domain allocation set for multi-shared channel communications. Each TDRA entry of the set of TDRA entries may include a respective set of parameters associated with a respective semi-persistent communication configuration. In some aspects, the respective set of parameters may indicate a respective offset value (K0 or K2), a respective mapping type, and a respective start and length indicator value (SLIV). In some aspects, the DCI transmission may include a set of RV fields associated with the set of semi-persistent communication configurations. The DCI transmission may include at least one additional RV field that is not associated with the set of semi-persistent communication configurations.

For example, in some aspects, a single TDRA field in the DCI transmission may indicate up to N TDRA entries used for up to N SPS configurations or CG configurations respectively, based on pdsch-TimeDomainAllocationListForMultiPDSCH/pusch-TimeDomainAllocationListForMultiPUSCH, each including a value of K0/K2, mapping type and SLIV, which may be used for up to N SPS configurations or CG configurations. A number of N RV fields in the joint activation DCI may indicate whether or not to activate each of N SPS configurations or CG configurations individually. For example, the nth SPS configuration or CG configuration may be indicated to be activated if the corresponding nth RV value (wherein n=0, N−1) is set to “0”s. For example, as shown by a schematic representation 634 of activation by a joint activation DCI (“DCI”) of two semi-persistent communication configurations (“SPS/CG 0” and “SPS/CG 1,” where each configuration is represented by two communication occasions 636 and 638, respectively), where N=2, since both the 0^{th} and 1^{st} RV fields are set to “0”s, a first corresponding semi-persistent communication configuration (shown as “SPS/CG 0”) and a second semi-persistent communication configuration (shown as “SPS/CG 1”) are activated. Otherwise, the nth SPS configuration or CG configuration may not be activated. In some aspects, if the number of RV fields in the DCI transmission is larger than N, the first Nth RV fields may be used for joint activation indication.

In some aspects, the DCI transmission may indicate at least one common parameter value associated with each of the set of semi-persistent communication configurations. For example, the DCI transmission may include a frequency domain resource allocation field that indicates one frequency allocation associated with each of the set of semi-persistent communication configurations. In some aspects, the DCI transmission may include an MCS field that indicates one MCS associated with each of the set of semi-persistent communication configurations. In some aspects, the DCI transmission may include a transmission configuration indicator (TCI) field that indicates one TCI state associated with each of the set of semi-persistent communication configurations. In some aspects, the DCI transmission may include a demodulation reference signal (DMRS) port indicator that indicates a set of DMRS ports associated with each of the set of semi-persistent communication configurations. In some aspects, the DCI transmission may include a precoder indicator that indicates a set of precoders associated with each of the set of semi-persistent communication configurations.

As shown by reference number 640, the network node 602 and the network node 604 may communicate based at least in part on the activated set of semi-persistent communication configurations.

As indicated above, FIG. 6B is provided as an example. Other examples may differ from what is described with regard to FIG. 6B.

FIG. 6C is a diagram illustrating an example 642 of joint activation DCI associated with multiple semi-persistent communication configurations, in accordance with the present disclosure. As shown, example 642 includes the network node 602 and the network node 604 in communication with one another. As shown by reference number 644, the network node 604 may transmit, and the network node 602 may receive, a DCI transmission. The DCI transmission may include a joint activation indicative of an activation of a set of N semi-persistent communication configurations of the plurality of semi-persistent communication configurations. Example 642 is similar to example 622, depicted in FIG. 6B, except that, in example 642, as shown by the schematic representation 646, the joint activation is indicative of activation of only one of the semi-persistent communication configurations (SPS/CG 1). As shown by the table 648, the bits associated with the 1^{st} RV field are set to all “0s”, indicating activation of the SPS/CG 1 configuration and the bits associated with the 0^{th} RV field are all set to “1”s, indicating that the correspond SPS/CG 0 configuration is not to be activated.

As indicated above, FIG. 6C is provided as an example. Other examples may differ from what is described with regard to FIG. 6C.

FIG. 6D is a diagram illustrating an example 650 of joint deactivation DCI associated with multiple semi-persistent communication configurations, in accordance with the present disclosure. As shown, example 650 includes the network node 602 and the network node 604 in communication with one another.

As shown by reference number 652, the network node 604 may transmit, and the network node 602 may receive, configuration information. As explained in connection with FIG. 6A, the configuration information may be indicative of a plurality of semi-persistent communication configurations. Each semi-persistent communication configuration may correspond to a respective configuration index of a plurality of configuration indexes.

As shown by reference number 654, the network node 604 may transmit, and the network node 602 may receive, a DCI transmission. The DCI transmission may include a joint deactivation indicative of a deactivation of a set of semi-persistent communication configurations of the plurality of semi-persistent communication configurations. The set of semi-persistent communication configurations may include one or more semi-persistent communication configurations.

In some aspects, the configuration information may include a semi-persistent communication configuration deactivation state set that includes the plurality of semi-persistent communication configurations, and the joint deactivation indication may include a value of a HARQ process number field of the DCI transmission. For example, if the network node 602 is provided with a ConfiguredGrantConfigType2ActivationStateList or a sps-ConfigActivationStateList, a value of the HARQ process number field in the DCI transmission may indicate a corresponding entry for deactivating one or more uplink grant Type 2 PUSCH configurations or SPS PDSCH configurations.

In some aspects, the semi-persistent communication configuration activation state set may include a CG configuration deactivation state list and/or an SPS configuration deactivation state list. For example, in some aspects, a ConfiguredGrantConfigType2ActivationStateList may be a reused ConfiguredGrantConfigType2DectivationStateList, and an sps-ConfigActivationStateList may be a reused sps-ConfigDectivationStateList.

In some aspects, as shown by the table 656 in FIG. 6D, the DCI transmission may have a multi-shared channel DCI format (e.g., DCI format 0_1 or DCI format 1_1).

As shown, the joint activation indication may include a HARQ ID field. The HARQ ID field may indicate a HARQ ID value corresponding to the set of semi-persistent communication configurations. In some aspects, the network node 602 may be activated with all or a subset of N SPS configurations and/or CG configurations associated with the HARQ ID. For example, the HARQ ID value may correspond to at least one additional semi-persistent communication configuration that is excluded from the set of semi-persistent communication configurations.

In some aspects, the DCI transmission may include a TDRA field that indicates a set of TDRA entries associated with the set of semi-persistent communication configurations. The TDRA field may indicate the set of TDRA entries based on a time domain allocation set for multi-shared channel communications. Each TDRA entry of the set of TDRA entries may include a respective set of parameters associated with a respective semi-persistent communication configuration. In some aspects, the respective set of parameters may indicate a respective offset value (K0 or K2), a respective mapping type, and a respective start and length indicator value (SLIV) for each SPS or CG communications. In some aspects, the DCI transmission may include a set of RV fields associated with the set of semi-persistent communication configurations. The DCI transmission may include at least one additional RV field that is not associated with the set of semi-persistent communication configurations.

For example, in some aspects, the DCI transmission may indicate deactivation associated with all or a subset of N SPS configurations or CG configurations. In some aspects, a number of N RV fields may indicate whether or not to deactivate each of N SPS configurations or CG configurations individually. For example, the nth SPS configuration or CG configuration may be indicated to be deactivated if the corresponding nth RV value (e.g., where n=0, N−1) is set to “0”s. Otherwise, the nth SPS or CG may not be deactivated. For example, as shown by the schematic representation 658, where N=2, the 0^{th} RV value and the 1st RV value are both set to all “0”s, indicating deactivation of a first semi-persistent communication configuration (“SPS/CG 0”) and a second semi-persistent communication configuration (“SPS/CG 1”).

In some aspects, the DCI transmission may indicate at least one common parameter value associated with each of the set of semi-persistent communication configurations. For example, as shown, the DCI transmission may include an FDRA field that indicates at least one frequency allocation associated with each of the set of semi-persistent communication configurations. In some aspects, the DCI transmission may include an MCS field that indicates one MCS associated with each of the set of semi-persistent communication configurations. In some aspects, for DCI format 0_1, for example, the FDRA field may be set to all “0”s for FDRA Type 2 with parameter μ=1. Otherwise, the FDRA field may be set to all “1”s. For DCI format 1_1, the FDRA field may be set to all “0”s for FDRA Type 0 or dynamicSwitch, and the FDRA field may be set to all “1”s for FDRA Type 1. As shown, the MCS field may be set to all “1”s.

As shown by reference number 660, the network node 602 and the network node 604 may terminate communications (e.g., the set of activated semi-persistent communication configurations).

As indicated above, FIG. 6D is provided as an example. Other examples may differ from what is described with regard to FIG. 6D.

FIG. 6E is a diagram illustrating an example 662 of joint deactivation DCI associated with multiple semi-persistent communication configurations, in accordance with the present disclosure. As shown, example 662 includes the network node 602 and the network node 604 in communication with one another. As shown by reference number 664, the network node 604 may transmit, and the network node 602 may receive, a DCI transmission. The DCI transmission may include a joint deactivation indicative of a deactivation of a set of semi-persistent communication configurations of the plurality of semi-persistent communication configurations. Example 662 is similar to example 650, depicted in FIG. 6D, except that, in example 662, as shown by the schematic representation 666, the joint deactivation is indicative of deactivation of only one semi-persistent communication configuration (SPS/CG 1). As shown by the table 668, the bits associated with the 1st RV field are set to all “0s”, indicating activation of the SPS/CG 1 configuration and the bits associated with the 0th RV field are all set to “1”s, indicating that the correspond SPS/CG 0 configuration is not to be activated.

As indicated above, FIG. 6E is provided as an example. Other examples may differ from what is described with regard to FIG. 6E.

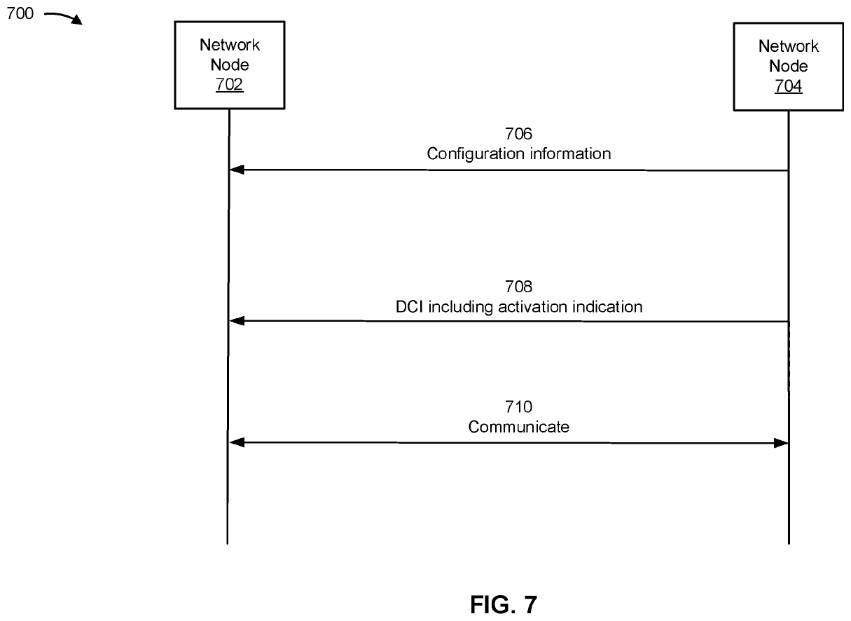

FIG. 7 is a diagram illustrating an example 700 associated with joint activation DCI associated with multiple semi-persistent communication configurations, in accordance with the present disclosure. As shown, example 700 includes a network node 702 and a network node 704 in communication with one another. In some aspects, the network node 702 and/or the network node 704 may be, be similar to, include, or be included in, the network node 602 and/or the network node 604 depicted in FIGS. 6A-6E, one or more of the components of the disaggregated base station architecture 500 depicted in FIG. 5, the network node 402 and/or the network node 404 depicted in FIG. 4, the network node 310 and/or the UE 320 depicted in FIG. 3, the apparatus 200 depicted in FIG. 2, and/or the network node 102A and/or the network node 102B depicted in FIG. 1.

As shown by reference number 706, the network node 704 may transmit, and the network node 702 may receive, configuration information. For example, the network node 702 may receive the configuration information via an RRC message transmitted by the network node 704. The configuration information may be indicative of a plurality of semi-persistent communication configurations. Each semi-persistent communication configuration may correspond to a respective configuration index. In some aspects, the semi-persistent communication configurations may include SPS configurations and/or CG configurations. SPS configurations may be associated with downlink communications and CG configurations may be associated with uplink communications. SPS communications may include periodic downlink communications that are configured for the network node 702, by the network node 704, such that the network node 704 does not need to send separate DCI to schedule each downlink communication, thereby conserving signaling overhead. CG communications may include periodic uplink communications that are configured for the network node 702, such that the network node 704 does not need to send separate DCI to schedule each uplink communication, thereby conserving signaling overhead.

As shown by reference number 708, the network node 704 may transmit, and the network node 702 may receive a DCI transmission. The DCI transmission may include a joint activation indication indicative of an activation of a set of semi-persistent communication configurations of the plurality of semi-persistent communication configurations. The set of semi-persistent communication configurations may include one or more of the plurality of semi-persistent communication configurations. The joint activation indication may activate the indicated semi-persistent communication configurations.

As shown by reference number 710, the network node 702 and the network node 704 may communicate based at least in part on the activated set of semi-persistent communication configurations or may terminate communications associated with the set of semi-persistent communication configurations. In some aspects, communicating may include communicating XR information.

As indicated above, FIG. 7 is provided as an example. Other examples may differ from what is described with regard to FIG. 7.

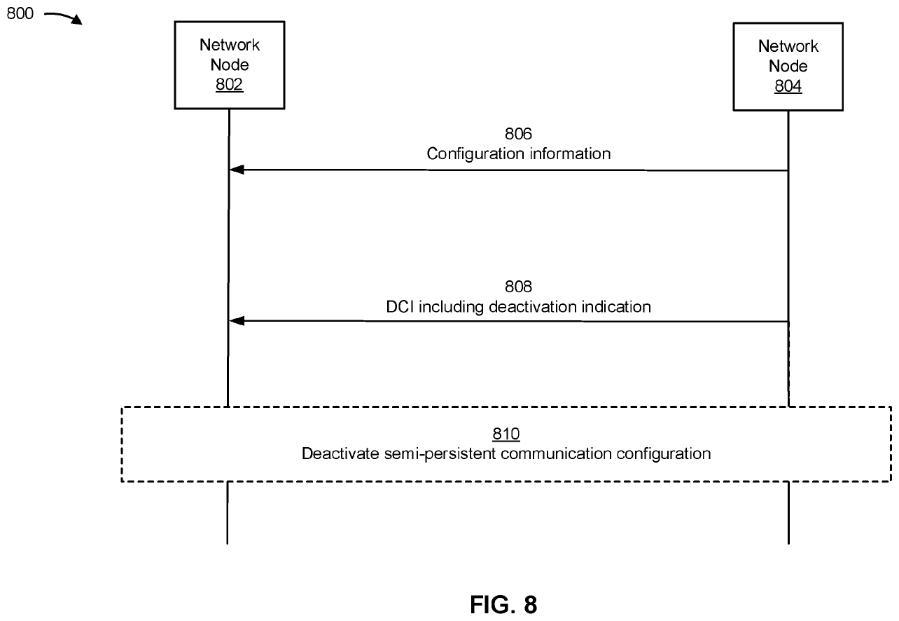

FIG. 8 is a diagram illustrating an example 800 associated with joint deactivation DCI associated with multiple semi-persistent communication configurations, in accordance with the present disclosure. As shown, example 800 includes a network node 802 and a network node 804 in communication with one another. In some aspects, the network node 802 and/or the network node 804 may be, be similar to, include, or be included in, the network node 702 and/or the network node 704 depicted in FIG. 7, the network node 602 and/or the network node 604 depicted in FIGS. 6A-6E, one or more of the components of the disaggregated base station architecture 500 depicted in FIG. 5, the network node 402 and/or the network node 404 depicted in FIG. 4, the network node 310 and/or the UE 320 depicted in FIG. 3, the apparatus 200 depicted in FIG. 2, and/or the network node 102A and/or the network node 102B depicted in FIG. 1.

As shown by reference number 806, the network node 804 may transmit, and the network node 802 may receive, configuration information. For example, the network node 802 may receive the configuration information via an RRC message transmitted by the network node 804. The configuration information may be indicative of a plurality of semi-persistent communication configurations.

As shown by reference number 808, the network node 804 may transmit, and the network node 802 may receive a DCI transmission. The DCI transmission may include a joint deactivation indication indicative of a deactivation of a set of semi-persistent communication configurations of the plurality of semi-persistent communication configurations. The set of semi-persistent communication configurations may include one or more of the plurality of semi-persistent communication configurations. The joint deactivation indication may deactivate the indicated semi-persistent communication configurations.

As shown by reference number 810, the network node 802 and the network node 804 may deactivate the set of semi-persistent communication configurations.

As indicated above, FIG. 8 is provided as an example. Other examples may differ from what is described with regard to FIG. 8.

FIG. 9 is a diagram illustrating an example process 900 performed, for example, by a network node, in accordance with the present disclosure. Example process 900 is an example where the network node (e.g., network node 602) performs operations associated with joint activation and/or deactivation downlink control information associated with multiple semi-persistent communication configurations.

As shown in FIG. 9, in some aspects, process 900 may include receiving configuration information indicative of a plurality of semi-persistent communication configurations, wherein each semi-persistent communication configuration corresponds to a respective configuration index of a plurality of configuration indexes (block 910).

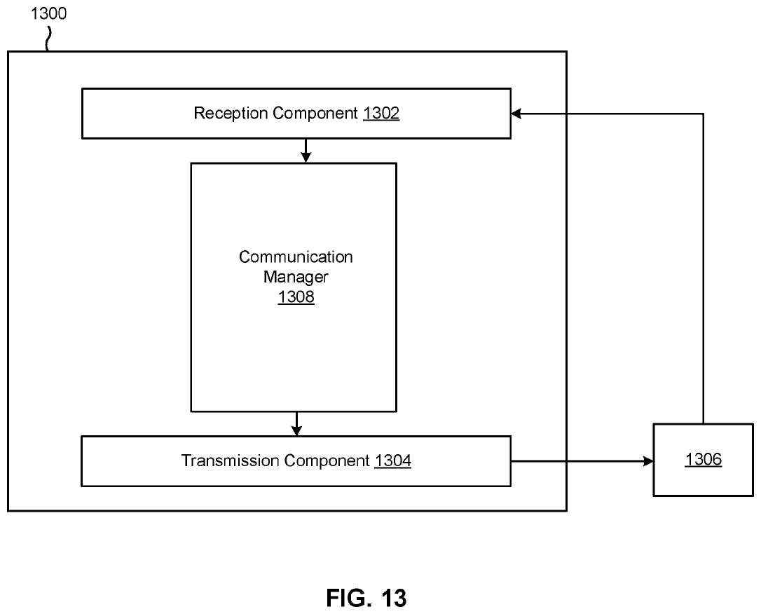

For example, the network node (e.g., using communication manager 1308 and/or reception component 1302, depicted in FIG. 13) may receive configuration information indicative of a plurality of semi-persistent communication configurations, wherein each semi-persistent communication configuration corresponds to a respective configuration index of a plurality of configuration indexes, as described above.

As further shown in FIG. 9, in some aspects, process 900 may include receiving a DCI transmission comprising a joint activation indication indicative of an activation of a set of semi-persistent communication configurations of the plurality of semi-persistent communication configurations, the set of semi-persistent communication configurations comprising one or more semi-persistent communication configurations (block 920). For example, the network node (e.g., using communication manager 1308 and/or reception component 1302, depicted in FIG. 13) may receive a DCI transmission comprising a joint activation indication indicative of an activation of a set of semi-persistent communication configurations of the plurality of semi-persistent communication configurations, the set of semi-persistent communication configurations comprising one or more semi-persistent communication configurations, as described above.

As further shown in FIG. 9, in some aspects, process 900 may include communicating based on the set of semi-persistent communication configurations (block 930). For example, the network node (e.g., using communication manager 1308, reception component 1302, and/or transmission component 1304, depicted in FIG. 13) may communicate based on the set of semi-persistent communication configurations, as described above.

Process 900 may include additional aspects, such as any single aspect or any combination of aspects described below and/or in connection with one or more other processes described elsewhere herein.

In a first aspect, the plurality of semi-persistent communication configurations comprises at least one of a configured grant configuration or a semi-persistent scheduling configuration.

In a second aspect, alone or in combination with the first aspect, receiving the configuration information comprises receiving a radio resource control message that includes the configuration information.

In a third aspect, alone or in combination with one or more of the first and second aspects, the joint activation indication is associated with an HARQ ID.

In a fourth aspect, alone or in combination with one or more of the first through third aspects, the configuration information comprises a semi-persistent communication configuration activation state set that includes the plurality of semi-persistent communication configurations, and wherein the joint activation indication comprises a value of a HARQ process number field of the DCI transmission.

In a fifth aspect, alone or in combination with one or more of the first through fourth aspects, the semi-persistent communication configuration activation state set comprises a configured grant configuration deactivation state list.

In a sixth aspect, alone or in combination with one or more of the first through fifth aspects, the semi-persistent communication configuration activation state set comprises a semi-persistent scheduling configuration deactivation state list.

In a seventh aspect, alone or in combination with one or more of the first through sixth aspects, the semi-persistent communication configuration activation state set comprises a configured grant configuration activation state list that is different from a configured grant configuration deactivation state list.

In an eighth aspect, alone or in combination with one or more of the first through seventh aspects, the semi-persistent communication configuration activation state set comprises a semi-persistent scheduling configuration activation state list that is different from a semi-persistent scheduling configuration deactivation state list.

In a ninth aspect, alone or in combination with one or more of the first through eighth aspects, the DCI transmission has a multi-shared channel DCI format, and wherein the joint activation indication comprises a HARQ ID field.

In a tenth aspect, alone or in combination with one or more of the first through ninth aspects, the HARQ ID field indicates a HARQ ID value corresponding to the set of semi-persistent communication configurations.

In an eleventh aspect, alone or in combination with one or more of the first through tenth aspects, the HARQ ID value corresponds to at least one additional semi-persistent communication configuration that is excluded from the set of semi-persistent communication configurations.

In a twelfth aspect, alone or in combination with one or more of the first through eleventh aspects, the DCI transmission comprises a time domain resource allocation (TDRA) field that indicates a set of TDRA entries associated with the set of semi-persistent communication configurations.

In a thirteenth aspect, alone or in combination with one or more of the first through twelfth aspects, the TDRA field indicates the set of TDRA entries based on a time domain allocation set for multi-shared channel communications.

In a fourteenth aspect, alone or in combination with one or more of the first through thirteenth aspects, each TDRA entry of the set of TDRA entries comprises a respective set of parameters associated with a respective semi-persistent communication configuration.

In a fifteenth aspect, alone or in combination with one or more of the first through fourteenth aspects, the respective set of parameters indicates a respective offset value, a respective mapping type, and a respective start and length indicator value.

In a sixteenth aspect, alone or in combination with one or more of the first through fifteenth aspects, the DCI transmission comprises a set of redundancy version (RV) fields associated with the set of semi-persistent communication configurations.

In a seventeenth aspect, alone or in combination with one or more of the first through sixteenth aspects, the DCI transmission comprises at least one additional RV field that is not associated with the set of semi-persistent communication configurations.

In an eighteenth aspect, alone or in combination with one or more of the first through seventeenth aspects, the DCI transmission indicates at least one common parameter value associated with the set of semi-persistent communication configurations.

In a nineteenth aspect, alone or in combination with one or more of the first through eighteenth aspects, the DCI transmission includes a time domain resource allocation field that indicates one frequency allocation associated with the set of semi-persistent communication configurations.

In a twentieth aspect, alone or in combination with one or more of the first through nineteenth aspects, the DCI transmission includes a modulation and coding scheme (MCS) field that indicates one MCS associated with the set of semi-persistent communication configurations.

In a twenty-first aspect, alone or in combination with one or more of the first through twentieth aspects, the DCI transmission includes a TCI field that indicates one TI state associated with the set of semi-persistent communication configurations.

In a twenty-second aspect, alone or in combination with one or more of the first through twenty-first aspects, the DCI transmission includes a demodulation reference signal (DMRS) port indicator that indicates a set of DMRS ports associated with the set of semi-persistent communication configurations.

In a twenty-third aspect, alone or in combination with one or more of the first through twenty-second aspects, the DCI transmission includes a precoder indicator that indicates a set of precoders associated with the set of semi-persistent communication configurations.

In a twenty-fourth aspect, alone or in combination with one or more of the first through twenty-third aspects, communicating comprises communicating extended reality information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 604) performs operations associated with joint activation and/or deactivation downlink control information associated with multiple semi-persistent communication configurations.

As shown in FIG. 10, in some aspects, process 1000 may include transmitting, configuration information indicative of a plurality of semi-persistent communication configurations, wherein each semi-persistent communication configuration corresponds to a respective configuration index of a plurality of configuration indexes (block 1010).

For example, the network node (e.g., using communication manager 1308 and/or transmission component 1304, depicted in FIG. 13) may transmit, configuration information indicative of a plurality of semi-persistent communication configurations, wherein each semi-persistent communication configuration corresponds to a respective configuration index of a plurality of configuration indexes, as described above.

As further shown in FIG. 10, in some aspects, process 1000 may include transmitting a DCI transmission comprising a joint activation indication indicative of an activation of a set of semi-persistent communication configurations of the plurality of semi-persistent communication configurations, the set of semi-persistent communication configurations comprising one or more semi-persistent communication configurations (block 1020). For example, the network node (e.g., using communication manager 1308 and/or transmission component 1304, depicted in FIG. 13) may transmit a DCI transmission comprising a joint activation indication indicative of an activation of a set of semi-persistent communication configurations of the plurality of semi-persistent communication configurations, the set of semi-persistent communication configurations comprising one or more semi-persistent communication configurations, as described above.

As further shown in FIG. 10, in some aspects, process 1000 may include communicating based on the set of semi-persistent communication configurations (block 1030). For example, the network node (e.g., using communication manager 1308, reception component 1302, and/or transmission component 1304, depicted in FIG. 13) may communicate based on the set of semi-persistent communication configurations, as described above.

Process 1000 may include additional aspects, such as any single aspect or any combination of aspects described below and/or in connection with one or more other processes described elsewhere herein.

In a first aspect, the plurality of semi-persistent communication configurations comprises at least one of a configured grant configuration or a semi-persistent scheduling configuration.

In a second aspect, alone or in combination with the first aspect, transmitting the configuration information comprises transmitting a radio resource control message that includes the configuration information.

In a third aspect, alone or in combination with one or more of the first and second aspects, the joint activation indication is associated with an HARQ ID.

In a fourth aspect, alone or in combination with one or more of the first through third aspects, the configuration information comprises a semi-persistent communication configuration activation state set that includes the plurality of semi-persistent communication configurations, and wherein the joint activation indication comprises a value of a HARQ process number field of the DCI transmission.

In a fifth aspect, alone or in combination with one or more of the first through fourth aspects, the semi-persistent communication configuration activation state set comprises a configured grant configuration deactivation state list.

In a sixth aspect, alone or in combination with one or more of the first through fifth aspects, the semi-persistent communication configuration activation state set comprises a semi-persistent scheduling configuration deactivation state list.

In a seventh aspect, alone or in combination with one or more of the first through sixth aspects, the semi-persistent communication configuration activation state set comprises a configured grant configuration activation state list that is different from a configured grant configuration deactivation state list.

In an eighth aspect, alone or in combination with one or more of the first through seventh aspects, the semi-persistent communication configuration activation state set comprises a semi-persistent scheduling configuration activation state list that is different from a semi-persistent scheduling configuration deactivation state list.

In a ninth aspect, alone or in combination with one or more of the first through eighth aspects, the DCI transmission has a multi-shared channel DCI format, and wherein the joint activation indication comprises a HARQ ID field.

In a tenth aspect, alone or in combination with one or more of the first through ninth aspects, the HARQ ID field indicates a HARQ ID value corresponding to the set of semi-persistent communication configurations.

In an eleventh aspect, alone or in combination with one or more of the first through tenth aspects, the HARQ ID value corresponds to at least one additional semi-persistent communication configuration that is excluded from the set of semi-persistent communication configurations.

In a twelfth aspect, alone or in combination with one or more of the first through eleventh aspects, the DCI transmission comprises a time domain resource allocation (TDRA) field that indicates a set of TDRA entries associated with the set of semi-persistent communication configurations.

In a thirteenth aspect, alone or in combination with one or more of the first through twelfth aspects, the TDRA field indicates the set of TDRA entries based on a time domain allocation set for multi-shared channel communications.

In a fourteenth aspect, alone or in combination with one or more of the first through thirteenth aspects, each TDRA entry of the set of TDRA entries comprises a respective set of parameters associated with a respective semi-persistent communication configuration.

In a fifteenth aspect, alone or in combination with one or more of the first through fourteenth aspects, the respective set of parameters indicates a respective offset value, a respective mapping type, and a respective start and length indicator value.

In a sixteenth aspect, alone or in combination with one or more of the first through fifteenth aspects, the DCI transmission comprises a set of redundancy version (RV) fields associated with the set of semi-persistent communication configurations.

In a seventeenth aspect, alone or in combination with one or more of the first through sixteenth aspects, the DCI transmission comprises at least one additional RV field that is not associated with the set of semi-persistent communication configurations.

In an eighteenth aspect, alone or in combination with one or more of the first through seventeenth aspects, the DCI transmission indicates at least one common parameter value associated with the set of semi-persistent communication configurations.

In a nineteenth aspect, alone or in combination with one or more of the first through eighteenth aspects, the DCI transmission includes a time domain resource allocation field that indicates one frequency allocation associated with the set of semi-persistent communication configurations.

In a twentieth aspect, alone or in combination with one or more of the first through nineteenth aspects, the DCI transmission includes a modulation and coding scheme (MCS) field that indicates one MCS associated with the set of semi-persistent communication configurations.

In a twenty-first aspect, alone or in combination with one or more of the first through twentieth aspects, the DCI transmission includes a transmission configuration indicator (TCI) field that indicates one TCI state associated with the set of semi-persistent communication configurations.

In a twenty-second aspect, alone or in combination with one or more of the first through twenty-first aspects, the DCI transmission includes a demodulation reference signal (DMRS) port indicator that indicates a set of DMRS ports associated with the set of semi-persistent communication configurations.

In a twenty-third aspect, alone or in combination with one or more of the first through twenty-second aspects, the DCI transmission includes a precoder indicator that indicates a set of precoders associated with the set of semi-persistent communication configurations.

In a twenty-fourth aspect, alone or in combination with one or more of the first through twenty-third aspects, communicating comprises communicating extended reality information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 602) performs operations associated with joint activation and/or deactivation downlink control information associated with multiple semi-persistent communication configurations.

As shown in FIG. 11, in some aspects, process 1100 may include receiving configuration information indicative of a plurality of semi-persistent communication configurations, wherein each semi-persistent communication configuration corresponds to a respective configuration index of a plurality of configuration indexes (block 1110).

For example, the network node (e.g., using communication manager 1308 and/or reception component 1302, depicted in FIG. 13) may receive configuration information indicative of a plurality of semi-persistent communication configurations, wherein each semi-persistent communication configuration corresponds to a respective configuration index of a plurality of configuration indexes, as described above.

As further shown in FIG. 11, in some aspects, process 1100 may include receiving a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations (block 1120). For example, the network node (e.g., using communication manager 1308 and/or reception component 1302, depicted in FIG. 13) may receive a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations, as described above.

Process 1100 may include additional aspects, such as any single aspect or any combination of aspects described below and/or in connection with one or more other processes described elsewhere herein.

In a first aspect, the plurality of semi-persistent communication configurations comprises at least one of a configured grant configuration or a semi-persistent scheduling configuration.

In a second aspect, alone or in combination with the first aspect, receiving the configuration information comprises receiving a radio resource control message that includes the configuration information.

In a third aspect, alone or in combination with one or more of the first and second aspects, the joint deactivation indication is associated with an HARQ ID.

In a fourth aspect, alone or in combination with one or more of the first through third aspects, the configuration information comprises a semi-persistent communication configuration deactivation state set that includes the plurality of semi-persistent communication configurations, and wherein the joint deactivation indication comprises a value of a HARQ process number field of the DCI transmission.

In a fifth aspect, alone or in combination with one or more of the first through fourth aspects, the semi-persistent communication configuration deactivation state set comprises a configured grant configuration deactivation state list.

In a sixth aspect, alone or in combination with one or more of the first through fifth aspects, the semi-persistent communication configuration deactivation state set comprises a semi-persistent scheduling configuration deactivation state list.

In a seventh aspect, alone or in combination with one or more of the first through sixth aspects, the DCI transmission has a multi-shared channel DCI format, and wherein the joint deactivation indication comprises a HARQ ID field.

In an eighth aspect, alone or in combination with one or more of the first through seventh aspects, the HARQ ID field indicates a HARQ ID value corresponding to the set of semi-persistent communication configurations.

In a ninth aspect, alone or in combination with one or more of the first through eighth aspects, the DCI transmission comprises a time domain resource allocation (TDRA) field that indicates a set of TDRA entries associated with the set of semi-persistent communication configurations.

In a tenth aspect, alone or in combination with one or more of the first through ninth aspects, the DCI transmission comprises a set of redundancy version (RV) fields associated with the set of semi-persistent communication configurations.

In an eleventh aspect, alone or in combination with one or more of the first through tenth aspects, the DCI transmission indicates at least one common parameter value associated with the set of semi-persistent communication configurations.

In a twelfth aspect, alone or in combination with one or more of the first through eleventh aspects, the at least one common parameter value is indicated by at least one of a frequency domain resource allocation field or a modulation and coding scheme field.

In a thirteenth aspect, alone or in combination with one or more of the first through twelfth aspects, the plurality of semi-persistent communication configurations are associated with extended reality information.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 604) performs operations associated with joint activation and/or deactivation downlink control information associated with multiple semi-persistent communication configurations.

As shown in FIG. 12, in some aspects, process 1200 may include transmitting configuration information indicative of a plurality of semi-persistent communication configurations, wherein each semi-persistent communication configuration corresponds to a respective configuration index of a plurality of configuration indexes (block 1210).

For example, the network node (e.g., using communication manager 1308 and/or transmission component 1304, depicted in FIG. 13) may transmit configuration information indicative of a plurality of semi-persistent communication configurations, wherein each semi-persistent communication configuration corresponds to a respective configuration index of a plurality of configuration indexes, as described above.

As further shown in FIG. 12, in some aspects, process 1200 may include transmitting a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations (block 1220). For example, the network node (e.g., using communication manager 1308 and/or transmission component 1304, depicted in FIG. 13) may transmit a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations, as described above.

Process 1200 may include additional aspects, such as any single aspect or any combination of aspects described below and/or in connection with one or more other processes described elsewhere herein.

In a first aspect, the plurality of semi-persistent communication configurations comprises at least one of a configured grant configuration or a semi-persistent scheduling configuration.

In a second aspect, alone or in combination with the first aspect, transmitting the configuration information comprises transmitting a radio resource control message that includes the configuration information.

In a third aspect, alone or in combination with one or more of the first and second aspects, the joint deactivation indication is associated with an HARQ ID.

In a fourth aspect, alone or in combination with one or more of the first through third aspects, the configuration information comprises a semi-persistent communication configuration deactivation state set that includes the plurality of semi-persistent communication configurations, and wherein the joint deactivation indication comprises a value of a HARQ process number field of the DCI transmission.

In a fifth aspect, alone or in combination with one or more of the first through fourth aspects, the semi-persistent communication configuration deactivation state set comprises a configured grant configuration deactivation state list.

In a sixth aspect, alone or in combination with one or more of the first through fifth aspects, the semi-persistent communication configuration deactivation state set comprises a semi-persistent scheduling configuration deactivation state list.

In a seventh aspect, alone or in combination with one or more of the first through sixth aspects, the DCI transmission has a multi-shared channel DCI format, and wherein the joint deactivation indication comprises a HARQ ID field.

In an eighth aspect, alone or in combination with one or more of the first through seventh aspects, the HARQ ID field indicates a HARQ ID value corresponding to the set of semi-persistent communication configurations.

In a ninth aspect, alone or in combination with one or more of the first through eighth aspects, the DCI transmission comprises a time domain resource allocation (TDRA) field that indicates a set of TDRA entries associated with the set of semi-persistent communication configurations.

In a tenth aspect, alone or in combination with one or more of the first through ninth aspects, the DCI transmission comprises a set of redundancy version (RV) fields associated with the set of semi-persistent communication configurations.

In an eleventh aspect, alone or in combination with one or more of the first through tenth aspects, the DCI transmission indicates at least one common parameter value associated with the set of semi-persistent communication configurations.

In a twelfth aspect, alone or in combination with one or more of the first through eleventh aspects, the at least one common parameter value is indicated by at least one of a frequency domain resource allocation field or a modulation and coding scheme field.

In a thirteenth aspect, alone or in combination with one or more of the first through twelfth aspects, the plurality of semi-persistent communication configurations are associated with extended reality information.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308.

In some aspects, the apparatus 1300 may be configured to perform one or more operations described herein in connection with FIGS. 6A-8. Additionally, or alternatively, the apparatus 1300 may be configured to perform one or more processes described herein, such as process 900 of FIG. 9, process 1000 of FIG. 10, process 1100 of FIG. 11, process 1200 of FIG. 12, or a combination thereof. In some aspects, the apparatus 1300 and/or one or more components shown in FIG. 13 may include one or more components of the network nodes described in connection with FIG. 4.

Additionally, or alternatively, one or more components shown in FIG. 13 may be implemented within one or more components described in connection with FIG. 4.

Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network nodes described in connection with FIG. 4.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network nodes described in connection with FIG. 4. In some aspects, the transmission component 1304 may be co-located with the reception component 1302 in a transceiver.

The communication manager 1308 and/or the reception component 1302 may receive configuration information indicative of a plurality of semi-persistent communication configurations, wherein each semi-persistent communication configuration corresponds to a respective configuration index of a plurality of configuration indexes.

In some aspects, the communication manager 1308 may include one or more antennas, a modem, a controller/processor, a memory, or a combination thereof, of the network node described in connection with FIG. 4. In some aspects, the communication manager 1308 may include the reception component 1302 and/or the transmission component 1304. In some aspects, the communication manager 1308 may be, be similar to, include, or be included in, the communication manager 106 depicted in FIG. 1.

The communication manager 1308 and/or the reception component 1302 may receive a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The communication manager 1308, the reception component 1302, and/or the transmission component 1304 may communicate based on the set of semi-persistent communication configurations.

The communication manager 1308 and/or the transmission component 1304 may transmit, configuration information indicative of a plurality of semi-persistent communication configurations, wherein each semi-persistent communication configuration corresponds to a respective configuration index of a plurality of configuration indexes. The communication manager 1308 and/or the transmission component 1304 may transmit a DCI transmission comprising a joint activation indication indicative of an activation of a set of semi-persistent communication configurations of the plurality of semi-persistent communication configurations, the set of semi-persistent communication configurations comprising one or more semi-persistent communication configurations. The communication manager 1308, the reception component 1302, and/or the transmission component 1304 may communicate based on the set of semi-persistent communication configurations.

The communication manager 1308 and/or the reception component 1302 may receive configuration information indicative of a plurality of semi-persistent communication configurations, wherein each semi-persistent communication configuration corresponds to a respective configuration index of a plurality of configuration indexes. The communication manager 1308 and/or the reception component 1302 may receive a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

The communication manager 1308 and/or the transmission component 1304 may transmit configuration information indicative of a plurality of semi-persistent communication configurations, wherein each semi-persistent communication configuration corresponds to a respective configuration index of a plurality of configuration indexes. The communication manager 1308 and/or the transmission component 1304 may transmit a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

The number and arrangement of components shown in FIG. 13 are provided as an example. In practice, there may be additional components, fewer components, different components, or differently arranged components than those shown in FIG. 13.

Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

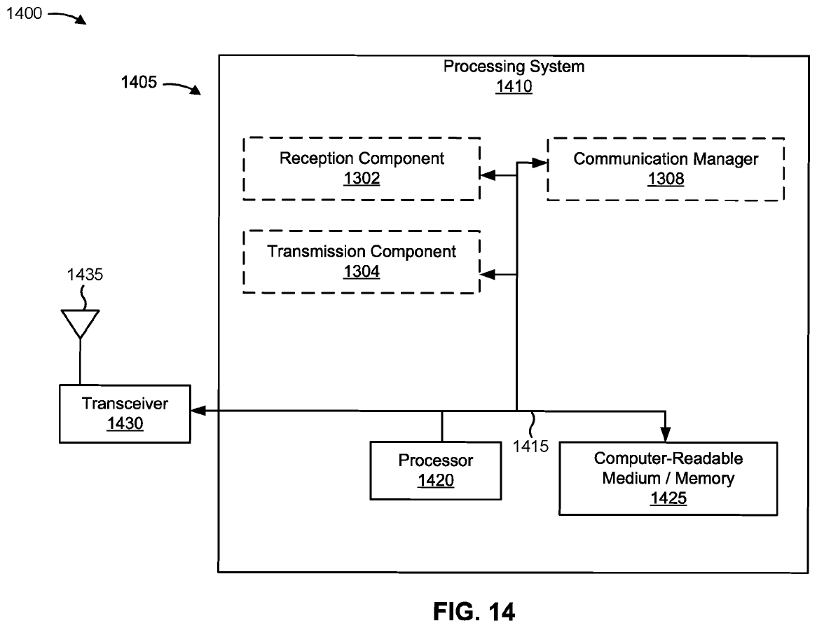

FIG. 14 is a diagram illustrating an example 1400 of a hardware implementation for an apparatus 1405 employing a processing system 1410, in accordance with the present disclosure. The apparatus 1405 may be a network node.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software.

The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the network node 404 and may include the memory 442 and/or at least one of the TX MIMO processor 440, the RX processor 422, and/or the controller/processor 426. In some aspects, the apparatus 1405 for wireless communication includes means for receiving configuration information indicative of a plurality of semi-persistent communication configurations, wherein each semi-persistent communication configuration corresponds to a respective configuration index of a plurality of configuration indexes; means for receiving a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and means for communicating based on the set of semi-persistent communication configurations. In some aspects, the apparatus 1405 for wireless communication includes means for transmitting configuration information indicative of a plurality of semi-persistent communication configurations, wherein each semi-persistent communication configuration corresponds to a respective configuration index of a plurality of configuration indexes; means for transmitting a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and means for communicating based on the set of semi-persistent communication configurations In some aspects, the apparatus 1405 for wireless communication includes means for receiving configuration information indicative of a plurality of semi-persistent communication configurations, wherein each semi-persistent communication configuration corresponds to a respective configuration index of a plurality of configuration indexes; and means for receiving a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations. In some aspects, the apparatus 1405 for wireless communication includes means for transmitting configuration information indicative of a plurality of semi-persistent communication configurations, wherein each semi-persistent communication configuration corresponds to a respective configuration index of a plurality of configuration indexes; and means for transmitting a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 440, the RX processor 422, and/or the controller/processor 426. In one configuration, the aforementioned means may be the TX MIMO processor 440, the RX processor 422, and/or the controller/processor 426 configured to perform the functions and/or operations recited herein.

In some aspects, the processing system 1410 may be a component of the network node 402 and may include the memory 456 and/or at least one of the TX MIMO processor 414, the RX processor 446, and/or the controller/processor 450. In some aspects, the apparatus 1405 for wireless communication includes means for receiving configuration information indicative of a plurality of semi-persistent communication configurations, wherein each semi-persistent communication configuration corresponds to a respective configuration index of a plurality of configuration indexes; means for receiving a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and means for communicating based on the set of semi-persistent communication configurations. In some aspects, the apparatus 1405 for wireless communication includes means for transmitting configuration information indicative of a plurality of semi-persistent communication configurations, wherein each semi-persistent communication configuration corresponds to a respective configuration index of a plurality of configuration indexes; means for transmitting a DCI transmission comprising a joint activation indication indicative of an activation of a set of semi-persistent communication configurations of the plurality of semi-persistent communication configurations, the set of semi-persistent communication configurations comprising one or more semi-persistent communication configurations; and means for communicating based on the set of semi-persistent communication configurations In some aspects, the apparatus 1405 for wireless communication includes means for receiving configuration information indicative of a plurality of semi-persistent communication configurations, wherein each semi-persistent communication configuration corresponds to a respective configuration index of a plurality of configuration indexes; and means for receiving a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations. In some aspects, the apparatus 1405 for wireless communication includes means for transmitting configuration information indicative of a plurality of semi-persistent communication configurations, wherein each semi-persistent communication configuration corresponds to a respective configuration index of a plurality of configuration indexes; and means for transmitting a DCI transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 414, the RX processor 446, and/or the controller/processor 450. In one configuration, the aforementioned means may be the TX MIMO processor 414, the RX processor 446, and/or the controller/processor 450 configured to perform the functions and/or operations recited herein.

FIG. 14 is provided as an example. Other examples may differ from what is described in connection with FIG. 14.

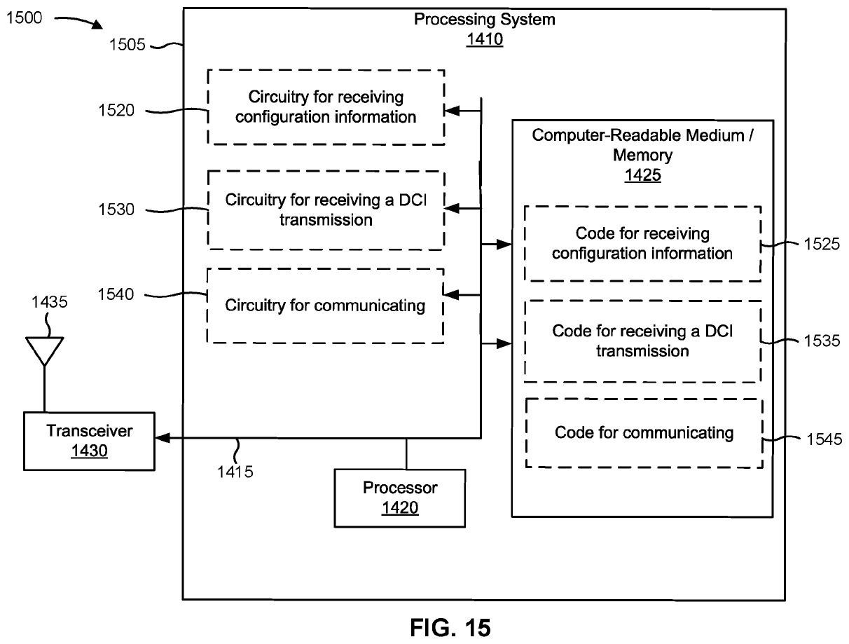

FIG. 15 is a diagram illustrating an example 1500 of an implementation of code and circuitry for an apparatus 1505, in accordance with the present disclosure. The apparatus 1505 may be a network node, or a network node may include the apparatus 1505.

As shown in FIG. 15, the apparatus 1505 may include circuitry for receiving configuration information indicative of a plurality of semi-persistent communication configurations, wherein each semi-persistent communication configuration corresponds to a respective configuration index of a plurality of configuration indexes (circuitry 1520). For example, the circuitry 1520 may enable the apparatus 1505 to receive configuration information indicative of a plurality of semi-persistent communication configurations, wherein each semi-persistent communication configuration corresponds to a respective configuration index of a plurality of configuration indexes.

As shown in FIG. 15, the apparatus 1505 may include, stored in computer-readable medium 1425, code for receiving configuration information indicative of a plurality of semi-persistent communication configurations, wherein each semi-persistent communication configuration corresponds to a respective configuration index of a plurality of configuration indexes (code 1525). For example, the code 1525, when executed by processor 1420, may cause processor 1420 to cause transceiver 1430 to receive configuration information indicative of a plurality of semi-persistent communication configurations, wherein each semi-persistent communication configuration corresponds to a respective configuration index of a plurality of configuration indexes.

As shown in FIG. 15, the apparatus 1505 may include circuitry for receiving a DCI transmission comprising a joint activation and/or deactivation indication indicative of an activation and/or a deactivation of a set of semi-persistent communication configurations of the plurality of semi-persistent communication configurations, the set of semi-persistent communication configurations comprising one or more semi-persistent communication configurations (circuitry 1530). For example, the circuitry 1530 may enable the apparatus 1505 to receive a DCI transmission comprising a joint activation and/or a deactivation indication indicative of an activation and/or a deactivation of a set of semi-persistent communication configurations of the plurality of semi-persistent communication configurations, the set of semi-persistent communication configurations comprising one or more semi-persistent communication configurations.

As shown in FIG. 15, the apparatus 1505 may include, stored in computer-readable medium 1425, code for receiving a DCI transmission comprising a joint activation indication and/or a deactivation indicative of an activation and/or a deactivation of a set of semi-persistent communication configurations of the plurality of semi-persistent communication configurations, the set of semi-persistent communication configurations comprising one or more semi-persistent communication configurations (code 1535). For example, the code 1535, when executed by processor 1420, may cause processor 1420 to cause transceiver 1430 to receive a DCI transmission comprising a joint activation and/or a deactivation indication indicative of an activation and/or a deactivation of a set of semi-persistent communication configurations of the plurality of semi-persistent communication configurations, the set of semi-persistent communication configurations comprising one or more semi-persistent communication configurations.

As shown in FIG. 15, the apparatus 1505 may include circuitry for communicating based on the set of semi-persistent communication configurations (circuitry 1540). For example, the circuitry 1540 may enable the apparatus 1505 to communicate based on the set of semi-persistent communication configurations.

As shown in FIG. 15, the apparatus 1505 may include, stored in computer-readable medium 1425, code for communicating based on the set of semi-persistent communication configurations (code 1545). For example, the code 1545, when executed by processor 1420, may cause processor 1420 to cause transceiver 1430 to communicate based on the set of semi-persistent communication configurations.

FIG. 15 is provided as an example. Other examples may differ from what is described in connection with FIG. 15.

The following provides an overview of some Aspects of the present disclosure:
Aspect 1: A method of wireless communication performed by a network node, comprising: receiving configuration information indicative of a plurality of semi-persistent communication configurations, wherein each semi-persistent communication configuration corresponds to a respective configuration index of a plurality of configuration indexes; receiving a downlink control information (DCI) transmission comprising a joint activation indication indicative of an activation of a set of semi-persistent communication configurations of the plurality of semi-persistent communication configurations, the set of semi-persistent communication configurations comprising one or more semi-persistent communication configurations; and communicating based on the set of semi-persistent communication configurations.
Aspect 2: The method of Aspect 1, wherein the plurality of semi-persistent communication configurations comprises at least one of a configured grant configuration or a semi-persistent scheduling configuration.
Aspect 3: The method of either of Aspects 1 or 2, wherein receiving the configuration information comprises receiving a radio resource control message that includes the configuration information.
Aspect 4: The method of any of Aspects 1-3, wherein the joint activation indication is associated with a hybrid automatic repeat request (HARQ) identifier (ID).
Aspect 5: The method of Aspect 4, wherein the configuration information comprises a semi-persistent communication configuration activation state set that includes the plurality of semi-persistent communication configurations, and wherein the joint activation indication comprises a value of a HARQ process number field of the DCI transmission.
Aspect 6: The method of Aspect 5, wherein the semi-persistent communication configuration activation state set comprises a configured grant configuration deactivation state list.
Aspect 7: The method of either of Aspects 5 or 6, wherein the semi-persistent communication configuration activation state set comprises a semi-persistent scheduling configuration deactivation state list.
Aspect 8: The method of Aspect 5, wherein the semi-persistent communication configuration activation state set comprises a configured grant configuration activation state list that is different from a configured grant configuration deactivation state list.
Aspect 9: The method of either of Aspects 5 or 8, wherein the semi-persistent communication configuration activation state set comprises a semi-persistent scheduling configuration activation state list that is different from a semi-persistent scheduling configuration deactivation state list.
Aspect 10: The method of any of Aspects 4-9, wherein the DCI transmission has a multi-shared channel DCI format, and wherein the joint activation indication comprises a HARQ ID field.
Aspect 11: The method of Aspect 10, wherein the HARQ ID field indicates a HARQ ID value corresponding to the set of semi-persistent communication configurations.
Aspect 12: The method of Aspect 11, wherein the HARQ ID value corresponds to at least one additional semi-persistent communication configuration that is excluded from the set of semi-persistent communication configurations.
Aspect 13: The method of any of Aspects 1-12, wherein the DCI transmission comprises a time domain resource allocation (TDRA) field that indicates a set of TDRA entries associated with the set of semi-persistent communication configurations.
Aspect 14: The method of Aspect 13, wherein the TDRA field indicates the set of TDRA entries based on a time domain allocation set for multi-shared channel communications.
Aspect 15: The method of Aspect 14, wherein each TDRA entry of the set of TDRA entries comprises a respective set of parameters associated with a respective semi-persistent communication configuration.
Aspect 16: The method of Aspect 15, wherein the respective set of parameters indicates a respective offset value, a respective mapping type, and a respective start and length indicator value.
Aspect 17: The method of any of Aspects 1-16, wherein the DCI transmission comprises a set of redundancy version (RV) fields associated with the set of semi-persistent communication configurations.
Aspect 18: The method of Aspect 17, wherein the DCI transmission comprises at least one additional RV field that is not associated with the set of semi-persistent communication configurations.
Aspect 19: The method of any of Aspects 1-18, wherein the DCI transmission indicates at least one common parameter value associated with the set of semi-persistent communication configurations.
Aspect 20: The method of any of Aspects 1-19, wherein the DCI transmission includes a time domain resource allocation field that indicates one frequency allocation associated with the set of semi-persistent communication configurations.
Aspect 21: The method of any of Aspects 1-20, wherein the DCI transmission includes a modulation and coding scheme (MCS) field that indicates one MCS associated with the set of semi-persistent communication configurations.
Aspect 22: The method of any of Aspects 1-21, wherein the DCI transmission includes a transmission configuration indicator (TCI) field that indicates one TCJ state associated with the set of semi-persistent communication configurations.
Aspect 23: The method of any of Aspects 1-22, wherein the DCI transmission includes a demodulation reference signal (DMRS) port indicator that indicates a set of DMRS ports associated with the set of semi-persistent communication configurations.
Aspect 24: The method of any of Aspects 1-23, wherein the DCI transmission includes a precoder indicator that indicates a set of precoders associated with the set of semi-persistent communication configurations.
Aspect 25: The method of any of Aspects 1-24, wherein communicating comprises communicating extended reality information.
Aspect 26: A method of wireless communication performed by a network node, comprising: transmitting, configuration information indicative of a plurality of semi-persistent communication configurations, wherein each semi-persistent communication configuration corresponds to a respective configuration index of a plurality of configuration indexes; transmitting a downlink control information (DCI) transmission comprising a joint activation indication indicative of an activation of a set of semi-persistent communication configurations of the plurality of semi-persistent communication configurations, the set of semi-persistent communication configurations comprising one or more semi-persistent communication configurations; and communicating based on the set of semi-persistent communication configurations.
Aspect 27: The method of Aspect 26, wherein the plurality of semi-persistent communication configurations comprises at least one of a configured grant configuration or a semi-persistent scheduling configuration.
Aspect 28: The method of either of Aspects 26 or 27, wherein transmitting the configuration information comprises transmitting a radio resource control message that includes the configuration information.
Aspect 29: The method of any of Aspects 26-28, wherein the joint activation indication is associated with a hybrid automatic repeat request (HARQ) identifier (ID).
Aspect 30: The method of Aspect 29, wherein the configuration information comprises a semi-persistent communication configuration activation state set that includes the plurality of semi-persistent communication configurations, and wherein the joint activation indication comprises a value of a HARQ process number field of the DCI transmission.
Aspect 31: The method of Aspect 30, wherein the semi-persistent communication configuration activation state set comprises a configured grant configuration deactivation state list.
Aspect 32: The method of either of Aspects 30 or 31, wherein the semi-persistent communication configuration activation state set comprises a semi-persistent scheduling configuration deactivation state list.
Aspect 33: The method of Aspect 30, wherein the semi-persistent communication configuration activation state set comprises a configured grant configuration activation state list that is different from a configured grant configuration deactivation state list.
Aspect 34: The method of either of Aspects 30 or 33, wherein the semi-persistent communication configuration activation state set comprises a semi-persistent scheduling configuration activation state list that is different from a semi-persistent scheduling configuration deactivation state list.
Aspect 35: The method of any of Aspects 29-34, wherein the DCI transmission has a multi-shared channel DCI format, and wherein the joint activation indication comprises a HARQ ID field.
Aspect 36: The method of Aspect 35, wherein the HARQ ID field indicates a HARQ ID value corresponding to the set of semi-persistent communication configurations.
Aspect 37: The method of Aspect 36, wherein the HARQ ID value corresponds to at least one additional semi-persistent communication configuration that is excluded from the set of semi-persistent communication configurations.
Aspect 38: The method of any of Aspects 26-37, wherein the DCI transmission comprises a time domain resource allocation (TDRA) field that indicates a set of TDRA entries associated with the set of semi-persistent communication configurations.
Aspect 39: The method of Aspect 38, wherein the TDRA field indicates the set of TDRA entries based on a time domain allocation set for multi-shared channel communications.
Aspect 40: The method of Aspect 39, wherein each TDRA entry of the set of TDRA entries comprises a respective set of parameters associated with a respective semi-persistent communication configuration.
Aspect 41: The method of Aspect 40, wherein the respective set of parameters indicates a respective offset value, a respective mapping type, and a respective start and length indicator value.
Aspect 42: The method of any of Aspects 26-41, wherein the DCI transmission comprises a set of redundancy version (RV) fields associated with the set of semi-persistent communication configurations.
Aspect 43: The method of Aspect 42, wherein the DCI transmission comprises at least one additional RV field that is not associated with the set of semi-persistent communication configurations.
Aspect 44: The method of any of Aspects 26-43, wherein the DCI transmission indicates at least one common parameter value associated with the set of semi-persistent communication configurations.
Aspect 45: The method of any of Aspects 26-44, wherein the DCI transmission includes a time domain resource allocation field that indicates one frequency allocation associated with the set of semi-persistent communication configurations.
Aspect 46: The method of any of Aspects 26-45, wherein the DCI transmission includes a modulation and coding scheme (MCS) field that indicates one MCS associated with the set of semi-persistent communication configurations.
Aspect 47: The method of any of Aspects 26-46, wherein the DCI transmission includes a transmission configuration indicator (TCI) field that indicates one TCI state associated with the set of semi-persistent communication configurations.
Aspect 48: The method of any of Aspects 26-47, wherein the DCI transmission includes a demodulation reference signal (DMRS) port indicator that indicates a set of DMRS ports associated with the set of semi-persistent communication configurations.
Aspect 49: The method of any of Aspects 26-48, wherein the DCI transmission includes a precoder indicator that indicates a set of precoders associated with the set of semi-persistent communication configurations.
Aspect 50: The method of any of Aspects 26-49, wherein communicating comprises communicating extended reality information.
Aspect 51: A method of wireless communication performed by a network node, comprising: receiving configuration information indicative of a plurality of semi-persistent communication configurations, wherein each semi-persistent communication configuration corresponds to a respective configuration index of a plurality of configuration indexes; and receiving a downlink control information (DCI) transmission comprising a joint deactivation indication indicative of a deactivation of a set of semi-persistent communication configurations of the plurality of semi-persistent communication configurations, the set of semi-persistent communication configurations comprising one or more semi-persistent communication configurations.
Aspect 52: The method of Aspect 51, wherein the plurality of semi-persistent communication configurations comprises at least one of a configured grant configuration or a semi-persistent scheduling configuration.
Aspect 53: The method of either of Aspects 51 or 52, wherein receiving the configuration information comprises receiving a radio resource control message that includes the configuration information.
Aspect 54: The method of any of Aspects 51-53, wherein the joint deactivation indication is associated with a hybrid automatic repeat request (HARQ) identifier (ID).
Aspect 55: The method of Aspect 54, wherein the configuration information comprises a semi-persistent communication configuration deactivation state set that includes the plurality of semi-persistent communication configurations, and wherein the joint deactivation indication comprises a value of a HARQ process number field of the DCI transmission.
Aspect 56: The method of Aspect 55, wherein the semi-persistent communication configuration deactivation state set comprises a configured grant configuration deactivation state list.
Aspect 57: The method of either of Aspects 55 or 56, wherein the semi-persistent communication configuration deactivation state set comprises a semi-persistent scheduling configuration deactivation state list.
Aspect 58: The method of any of Aspects 54-57, wherein the DCI transmission has a multi-shared channel DCI format, and wherein the joint deactivation indication comprises a HARQ ID field.
Aspect 59: The method of Aspect 58, wherein the HARQ ID field indicates a HARQ ID value corresponding to the set of semi-persistent communication configurations.
Aspect 60: The method of any of Aspects 51-59, wherein the DCI transmission comprises a time domain resource allocation (TDRA) field that indicates a set of TDRA entries associated with the set of semi-persistent communication configurations.
Aspect 61: The method of any of Aspects 51-60, wherein the DCI transmission comprises a set of redundancy version (RV) fields associated with the set of semi-persistent communication configurations.
Aspect 62: The method of any of Aspects 51-61, wherein the DCI transmission indicates at least one common parameter value associated with the set of semi-persistent communication configurations.
Aspect 63: The method of Aspect 62, wherein the at least one common parameter value is indicated by at least one of a frequency domain resource allocation field or a modulation and coding scheme field.
Aspect 64: The method of any of Aspects 51-63, wherein plurality of semi-persistent communication configurations are associated with extended reality information.
Aspect 65: A method of wireless communication performed by a network node, comprising: transmitting configuration information indicative of a plurality of semi-persistent communication configurations, wherein each semi-persistent communication configuration corresponds to a respective configuration index of a plurality of configuration indexes; and transmitting a downlink control information (DCI) transmission comprising a joint deactivation indication indicative of a deactivation of a set of semi-persistent communication configurations of the plurality of semi-persistent communication configurations, the set of semi-persistent communication configurations comprising one or more semi-persistent communication configurations.
Aspect 66: The method of Aspect 65, wherein the plurality of semi-persistent communication configurations comprises at least one of a configured grant configuration or a semi-persistent scheduling configuration.
Aspect 67: The method of either of Aspects 65 or 66, wherein transmitting the configuration information comprises transmitting a radio resource control message that includes the configuration information.
Aspect 68: The method of any of Aspects 65-67, wherein the joint deactivation indication is associated with a hybrid automatic repeat request (HARQ) identifier (ID).
Aspect 69: The method of Aspect 68, wherein the configuration information comprises a semi-persistent communication configuration deactivation state set that includes the plurality of semi-persistent communication configurations, and wherein the joint deactivation indication comprises a value of a HARQ process number field of the DCI transmission.
Aspect 70: The method of Aspect 69, wherein the semi-persistent communication configuration deactivation state set comprises a configured grant configuration deactivation state list.
Aspect 71: The method of either of Aspects 69 or 70, wherein the semi-persistent communication configuration deactivation state set comprises a semi-persistent scheduling configuration deactivation state list.
Aspect 72: The method of Aspect 68, wherein the DCI transmission has a multi-shared channel DCI format, and wherein the joint deactivation indication comprises a HARQ ID field.
Aspect 73: The method of Aspect 72, wherein the HARQ ID field indicates a HARQ ID value corresponding to the set of semi-persistent communication configurations.
Aspect 74: The method of any of Aspects 65-73, wherein the DCI transmission comprises a time domain resource allocation (TDRA) field that indicates a set of TDRA entries associated with the set of semi-persistent communication configurations.
Aspect 75: The method of any of Aspects 65-74, wherein the DCI transmission comprises a set of redundancy version (RV) fields associated with the set of semi-persistent communication configurations.
Aspect 76: The method of any of Aspects 65-75, wherein the DCI transmission indicates at least one common parameter value associated with the set of semi-persistent communication configurations.
Aspect 77: The method of Aspect 76, wherein the at least one common parameter value is indicated by at least one of a frequency domain resource allocation field or a modulation and coding scheme field.
Aspect 78: The method of any of Aspects 65-77, wherein plurality of semi-persistent communication configurations are associated with extended reality information.
Aspect 79: An apparatus for wireless communication at a device, comprising a processor; memory coupled with the processor; and instructions stored in the memory and executable by the processor to cause the apparatus to perform the method of one or more of Aspects 1-25.
Aspect 80: A device for wireless communication, comprising a memory and one or more processors coupled to the memory, the one or more processors configured to perform the method of one or more of Aspects 1-25.
Aspect 81: An apparatus for wireless communication, comprising at least one means for performing the method of one or more of Aspects 1-25.
Aspect 82: A non-transitory computer-readable medium storing code for wireless communication, the code comprising instructions executable by a processor to perform the method of one or more of Aspects 1-25.
Aspect 83: A non-transitory computer-readable medium storing a set of instructions for wireless communication, the set of instructions comprising one or more instructions that, when executed by one or more processors of a device, cause the device to perform the method of one or more of Aspects 1-25.
Aspect 84: An apparatus for wireless communication at a device, comprising a processor; memory coupled with the processor; and instructions stored in the memory and executable by the processor to cause the apparatus to perform the method of one or more of Aspects 26-50.
Aspect 85: A device for wireless communication, comprising a memory and one or more processors coupled to the memory, the one or more processors configured to perform the method of one or more of Aspects 26-50.
Aspect 86: An apparatus for wireless communication, comprising at least one means for performing the method of one or more of Aspects 26-50.
Aspect 87: A non-transitory computer-readable medium storing code for wireless communication, the code comprising instructions executable by a processor to perform the method of one or more of Aspects 26-50.
Aspect 88: A non-transitory computer-readable medium storing a set of instructions for wireless communication, the set of instructions comprising one or more instructions that, when executed by one or more processors of a device, cause the device to perform the method of one or more of Aspects 26-50.
Aspect 89: An apparatus for wireless communication at a device, comprising a processor; memory coupled with the processor; and instructions stored in the memory and executable by the processor to cause the apparatus to perform the method of one or more of Aspects 51-64.
Aspect 90: A device for wireless communication, comprising a memory and one or more processors coupled to the memory, the one or more processors configured to perform the method of one or more of Aspects 51-64.
Aspect 91: An apparatus for wireless communication, comprising at least one means for performing the method of one or more of Aspects 51-64.
Aspect 92: A non-transitory computer-readable medium storing code for wireless communication, the code comprising instructions executable by a processor to perform the method of one or more of Aspects 51-64.
Aspect 93: A non-transitory computer-readable medium storing a set of instructions for wireless communication, the set of instructions comprising one or more instructions that, when executed by one or more processors of a device, cause the device to perform the method of one or more of Aspects 51-64.
Aspect 94: An apparatus for wireless communication at a device, comprising a processor; memory coupled with the processor; and instructions stored in the memory and executable by the processor to cause the apparatus to perform the method of one or more of Aspects 65-78.
Aspect 95: A device for wireless communication, comprising a memory and one or more processors coupled to the memory, the one or more processors configured to perform the method of one or more of Aspects 65-78.
Aspect 96: An apparatus for wireless communication, comprising at least one means for performing the method of one or more of Aspects 65-78.
Aspect 97: A non-transitory computer-readable medium storing code for wireless communication, the code comprising instructions executable by a processor to perform the method of one or more of Aspects 65-78.
Aspect 98: A non-transitory computer-readable medium storing a set of instructions for wireless communication, the set of instructions comprising one or more instructions that, when executed by one or more processors of a device, cause the device to perform the method of one or more of Aspects 65-78.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a +a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors coupled to the memory, the one or more processors configured to:
receive configuration information indicative of a plurality of semi-persistent communication configurations, wherein each semi-persistent communication configuration corresponds to a respective configuration index of a plurality of configuration indexes;
receive a downlink control information (DCI) transmission comprising a joint activation indication indicative of an activation of a set of semi-persistent communication configurations of the plurality of semi-persistent communication configurations, the set of semi-persistent communication configurations comprising one or more semi-persistent communication configurations; and
communicate based on the set of semi-persistent communication configurations.

2. The network node of claim 1, wherein the plurality of semi-persistent communication configurations comprises at least one of a configured grant configuration or a semi-persistent scheduling configuration.

3. The network node of claim 1, wherein the one or more processors, to receive the configuration information, are configured to receive a radio resource control message that includes the configuration information, wherein the joint activation indication is associated with a hybrid automatic repeat request (HARQ) identifier (ID).

4. The network node of claim 3, wherein the configuration information comprises a semi-persistent communication configuration activation state set that includes the plurality of semi-persistent communication configurations, and wherein the joint activation indication comprises a value of a HARQ process number field of the DCI transmission.

5. The network node of claim 4, wherein the semi-persistent communication configuration activation state set comprises at least one of a configured grant configuration deactivation state list, a semi-persistent scheduling configuration deactivation state list, or a combination of a configured grant configuration deactivation state list and a semi-persistent scheduling configuration deactivation state list.

6. The network node of claim 3, wherein the DCI transmission has a multi-shared channel DCI format, and wherein the joint activation indication comprises a HARQ ID field that indicates a HARQ ID value corresponding to the set of semi-persistent communication configurations.

7. The network node of claim 1, wherein the DCI transmission comprises a time domain resource allocation (TDRA) field that indicates a set of TDRA entries associated with the set of semi-persistent communication configurations.

8. The network node of claim 7, wherein the TDRA field indicates the set of TDRA entries based on a time domain allocation set for multi-shared channel communications.

9. The network node of claim 8, wherein each TDRA entry of the set of TDRA entries comprises a respective set of parameters associated with a respective semi-persistent communication configuration, wherein the respective set of parameters indicates a respective offset value, a respective mapping type, and a respective start and length indicator value.

10. The network node of claim 1, wherein the DCI transmission comprises a set of redundancy version (RV) fields associated with the set of semi-persistent communication configurations.

11. The network node of claim 1, wherein the DCI transmission indicates at least one common parameter value associated with the set of semi-persistent communication configurations, wherein the at least one common parameter value indicates at least one of a frequency allocation, a modulation and coding scheme (MCS), a transmission configuration indicator (TCI) state, a set of demodulation reference signal (DMRS) ports, a set of precoders, or a combination of two or more of the MCS, the TCI state, the set of DMRS ports, or the set of precoders.

12. The network node of claim 1, wherein the one or more processors, to communicate, are configured to communicate extended reality information.

13. A network node for wireless communication, comprising:
a memory; and
one or more processors coupled to the memory, the one or more processors configured to:
transmit, configuration information indicative of a plurality of semi-persistent communication configurations, wherein each semi-persistent communication configuration corresponds to a respective configuration index of a plurality of configuration indexes;
transmit a downlink control information (DCI) transmission comprising a joint activation indication indicative of an activation of a set of semi-persistent communication configurations of the plurality of semi-persistent communication configurations, the set of semi-persistent communication configurations comprising one or more semi-persistent communication configurations; and
communicate based on the set of semi-persistent communication configurations.

14. The network node of claim 13, wherein the plurality of semi-persistent communication configurations comprises at least one of a configured grant configuration or a semi-persistent scheduling configuration.

15. The network node of claim 13, wherein the one or more processors, to transmit the configuration information, are configured to transmit a radio resource control message that includes the configuration information, wherein the joint activation indication is associated with a hybrid automatic repeat request (HARQ) identifier (ID).

16. The network node of claim 15, wherein the configuration information comprises a semi-persistent communication configuration activation state set that includes the plurality of semi-persistent communication configurations, and wherein the joint activation indication comprises a value of a HARQ process number field of the DCI transmission.

17. The network node of claim 16, wherein the semi-persistent communication configuration activation state set comprises at least one of a configured grant configuration deactivation state list, a semi-persistent scheduling configuration deactivation state list, or a combination of a configured grant configuration deactivation state list and a semi-persistent scheduling configuration deactivation state list.

18. The network node of claim 15, wherein the DCI transmission has a multi-shared channel DCI format, and wherein the joint activation indication comprises a HARQ ID field that indicates a HARQ ID value corresponding to the set of semi-persistent communication configurations.

19. The network node of claim 13, wherein the DCI transmission comprises a time domain resource allocation (TDRA) field that indicates a set of TDRA entries associated with the set of semi-persistent communication configurations.

20. The network node of claim 13, wherein the one or more processors, to communicate, are configured to communicate extended reality information.

21. A network node for wireless communication, comprising:
a memory; and
one or more processors coupled to the memory, the one or more processors configured to:
receive configuration information indicative of a plurality of semi-persistent communication configurations, wherein each semi-persistent communication configuration corresponds to a respective configuration index of a plurality of configuration indexes; and
receive a downlink control information (DCI) transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

22. The network node of claim 21, wherein the plurality of semi-persistent communication configurations comprises at least one of a configured grant configuration or a semi-persistent scheduling configuration.

23. The network node of claim 21, wherein the one or more processors, to receive the configuration information, are configured to receive a radio resource control message that includes the configuration information, wherein the joint deactivation indication is associated with a hybrid automatic repeat request (HARQ) identifier (ID).

24. The network node of claim 23, wherein the configuration information comprises a semi-persistent communication configuration deactivation state set that includes the plurality of semi-persistent communication configurations, and wherein the joint deactivation indication comprises a value of a HARQ process number field of the DCI transmission.

25. The network node of claim 24, wherein the semi-persistent communication configuration deactivation state set comprises at least one of a configured grant configuration deactivation state list, a semi-persistent scheduling configuration deactivation state list, or a combination of a configured grant configuration deactivation state list and a semi-persistent scheduling configuration deactivation state list.

26. A network node for wireless communication, comprising:
a memory; and
one or more processors coupled to the memory, the one or more processors configured to:
transmit configuration information indicative of a plurality of semi-persistent communication configurations, wherein each semi-persistent communication configuration corresponds to a respective configuration index of a plurality of configuration indexes; and
transmit a downlink control information (DCI) transmission comprising a joint deactivation indication indicative of a deactivation of a set of semi-persistent communication configurations of the plurality of semi-persistent communication configurations, the set of semi-persistent communication configurations comprising one or more semi-persistent communication configurations.

27. The network node of claim 26, wherein the plurality of semi-persistent communication configurations comprises at least one of a configured grant configuration, a semi-persistent scheduling configuration, or a combination of a configured grant configuration and a semi-persistent scheduling configuration.

28. The network node of claim 26, wherein the one or more processors, to transmit the configuration information, are configured to transmit a radio resource control message that includes the configuration information, wherein the joint deactivation indication is associated with a hybrid automatic repeat request (HARQ) identifier (ID).

29. The network node of claim 28, wherein the configuration information comprises a semi-persistent communication configuration deactivation state set that includes the plurality of semi-persistent communication configurations, and wherein the joint deactivation indication comprises a value of a HARQ process number field of the DCI transmission.

30. The network node of claim 29, wherein the semi-persistent communication configuration deactivation state set comprises at least one of a configured grant configuration deactivation state list, a semi-persistent scheduling configuration deactivation state list, or a combination of a configured grant configuration deactivation state list and a semi-persistent scheduling configuration deactivation state list.
